(19) United States
(12) Patent Application Publication
(10) Pub. No.: US 2025/0146151 A1
(43) Pub. Date: May 8, 2025

(54) BIMETALLIC ALLOY NANOSTRUCTURES FOR EFFICIENT AMMONIA ELECTROSYNTHESIS

(71) Applicant: City University of Hong Kong, Hong Kong (CN)

(72) Inventors: Zhanxi FAN, Hong Kong (CN); Yunhao WANG, Hong Kong (CN)

(21) Appl. No.: 18/501,168

(22) Filed: Nov. 3, 2023

(51) Int. Cl. C25B 11/089; C01C 1/02; C01G 55/00; C25B 1/27; C25B 9/17; C25B 11/02

(52) U.S. Cl. CPC C25B 11/089; C01C 1/02; C01G 55/00; C25B 1/27; C25B 9/17; C25B 11/02; C01P 2002/72; C01P 2002/76; C01P 2002/85; C01P 2004/04; C01P 2004/24; C01P 2004/62; C01P 2006/12; C01P 2006/40

(57) ABSTRACT

Ruthenium-iron nanoflower particles having a plurality of RuFe nanosheets, wherein the plurality of RuFe nanosheets are in a form of a nanoflower useful for the electrochemical synthesis of ammonia; an electrode including the RuFe nanoflower particles; and methods of preparation and use thereof.

### TECHNICAL FIELD

The present disclosure generally relates to a ruthenium-iron alloy nanoflower particle useful as an electrocatalyst in electrochemical synthesis of ammonia.

### BACKGROUND

Ammonia (NH₃), as one of the largest-volume industrial chemicals produced globally, is a carbon-free fuel, green energy carrier, important chemical feedstock, and essential precursor of fertilizers. Traditionally, NH₃ is massively generated by the Haber-Bosch method, which involves the energy-intensive reaction between nitrogen (N₂) and hydrogen (H₂) under high temperature and pressure (e.g., 300-500° C. and 20-25 MPa). As an appealing alternative, NH₃ synthesis via electrochemical nitrate reduction reaction (NO₃RR) has recently attracted tremendous research interest, due in part to its mild operation conditions and compatibility with renewable electricity resources. Notably, given the much lower energy needed for the cleavage of N═O bonds (204 kJ mol⁻¹) and the large solubility of nitrate (NO₃−) in aqueous solutions, NO₃RR is capable of delivering relatively higher selectivity and yield rate for NH₃ synthesis in comparison to nitrogen reduction. Moreover, NO₃⁻ ions are also known as one of the most widespread pollutants in groundwater and surface water, arising from excessive use of fertilizers, wastewater discharge, and other human activities. In light of this, NO₃RR provides a promising strategy to remediate NO₃⁻ waste and simultaneously produce valuable NH₃, which promotes a sustainable nitrogen cycle in the ecosystem. Ammonia electrosynthesis via NO₃RR is mainly composed of deoxygenation processes (e.g., NO₃⁻ to NO₂⁻) and the subsequent multiple hydrogenation steps (e.g., NO₂⁻ to NH₃), which involves complicated transfer processes of eight electrons and nine protons (i.e., NO₃⁻+9H⁺+8e⁻→NH₃+3H₂O). During NO₃RR, hydrogen evolution reaction (HER) is the dominant competing reaction, and meanwhile several other kinds of by-products like NO₂⁻, N₂, NH₂OH, NH₂NH₂ and N₂O can also form, making the efficient conversion from NO₃⁻ to NH₃ a significant challenge. Therefore, it is essential to develop electrocatalysts with excellent activity and selectivity for NH₃ synthesis from NO₃⁻.

Although several kinds of metal-based electrocatalysts, such as Cu, Ni, Pd and their compounds, have been developed for NO₃RR, their catalytic performance is still greatly limited by the kinetic mismatch of multiple transformation steps, leading to the accumulation of undesired N-containing species. Recently, ruthenium (Ru)-based materials have emerged as electrocatalysts for NO₃RR. Ru active sites can enhance the adsorption/desorption and activation of the most important intermediate (i.e., NO₂⁻ or *NO₂) during the reaction process, facilitating the subsequent conversion of NO₂- to NH₃. However, similar to the other platinum-group metals, Ru suffers from the problem of kinetically favoring competing HER rather than NO₃RR, owing to the high coverage of active hydrogen (*H) on its surface. The adsorbed *H will strongly compete for Ru active sites and thus lead to the insufficient adsorption and electron injection to the π* antibonding orbitals of NO₃⁻ ions, especially in neutral solutions, resulting in unsatisfactory activity and selectivity toward NH₃ generation. Tremendous efforts are still needed to overcome this problem. Generally, the introduction of another metal can modulate the electronic structure, local chemical environment and surface properties of Ru, and also tune the adsorption energies of reaction intermediates, thereby enhancing the activity and selectivity of Ru-based electrocatalysts.

There is thus a need for improved NO₃RR Ru-based electrocatalysts.

### SUMMARY

Among various metals, iron (Fe), which is an earth-abundant and cost-effective transition metal, can effectively adsorb NO₃⁻ and convert it to NO₂⁻, which is generally regarded as the rate-determining step in NO₃RR for most of metal-based heterogeneous catalysts. Therefore, it is proposed that combining Ru and Fe into one electrocatalyst could not only realize the efficient conversion of NO₃⁻ to NO₂⁻, but also ensure the rapid hydrogenation of NO₂⁻ to NH₃. Moreover, two-dimensional (2D) nanostructures have been identified as highly efficient catalysts for various catalytic applications. Note that the ultrathin 2D structures typically possess large specific surface areas, which can greatly accelerate the reaction kinetics. Based on the above considerations, ultrathin 2D Ru-Fe nanostructures could be an effective approach to boost the electrocatalytic reduction of NO₃⁻ to NH₃.

Provided herein are RuFe nanoflower (NF) particles comprising a plurality of nanosheets, which can be prepared by a one-pot solvothermal method. Compared with Ru nanosheets (NSs) and RuFe nanodendrites (NDs), RuFe NFs show superior catalytic activity and selectivity for NO₃RR toward NH₃ synthesis. Impressively, RuFe NFs deliver outstanding Faradaic efficiency (FE) of 92.9% and yield rate of 38.68 mg h⁻¹ mg_{cat}⁻¹(64.47 mg h⁻¹ mg_{Ru}⁻¹) at −0.30 and −0.65 V (vs reversible hydrogen evolution (RHE)) for NH₃ production, respectively, much higher than those of Ru NSs (80.1% and 5.66 mg h⁻¹ mg_{cat}⁻¹) and RuFe NDs (85.7% and 19.26 mg h⁻¹ mg_{cat}⁻¹). Meanwhile, RuFe NFs also demonstrate excellent electrocatalytic stability during consecutive electrolysis for 20 cycles. Experimental investigations and density functional theory (DFT) calculations reveal that the superior NO₃RR performance of RuFe NFs is ascribed to the electroactive low-coordinated Ru sites with increased d-band center and electroactivity. The Fe sites guarantee the stable valence states of Ru sites, which benefits the remarkable durability of RuFe NFs during NO₃⁻ electrolysis. The Ru sites strengthen the adsorption of intermediates and accelerate the reaction trend with lower energy barriers of the potential-determining steps during NO₃RR. In addition, the fabrication of rechargeable zinc-nitrate (Zn—NO₃⁻) battery with large specific capacity of 160,419 mAh g_{cat}⁻¹ (under the current density of 2.5 mA mg_{cat}⁻¹) is also performed by using RuFe NFs as the catalyst cathode.

In a first aspect, provided herein is a ruthenium-iron (RuFe) nanoflower particle comprising a plurality of RuFe nanosheets, wherein the plurality of RuFe nanosheets are in a form of a nanoflower.

In certain embodiments, the plurality of RuFe nanosheets comprise RuFe in a hexagonal close-packed (hcp) phase.

In certain embodiments, the RuFe nanoflower particle has a diameter of 150-250 nm.

In certain embodiments, the plurality of RuFe nanosheets have an average thickness of 1-3 nm.

In certain embodiments, the plurality of RuFe nanosheets have an average thickness of 1.5-2 nm.

In certain embodiments, the RuFe nanoflower particle comprises Ru and Fe in an atomic ratio of 48:52 to 48.5:51.5, respectively.

In certain embodiments, the RuFe nanoflower particle comprises Ru and Fe in an atomic ratio of 48.5:51.5 to 49.5:50.5, respectively.

In certain embodiments, RuFe nanoflower particle has an electrochemically active surface area of 200-267.5 cm².

In certain embodiments, the RuFe nanoflower particle has a diameter of 150-250 nm; the plurality of RuFe nanosheets have an average thickness of 1.5-2 nm; and the RuFe nanoflower particle comprises Ru and Fe in an atomic ratio of 48.5:51.5 to 49.5:50.5, respectively.

In certain embodiments, the RuFe nanoflower particle is prepared by a method comprising: contacting Ru₃(CO)₁₂, Fe(acac)₃, glucose, and citric acid in a solvent comprising oleylamine and n-octanol thereby forming a reaction solution and heating the reaction solution thereby forming the RuFe nanoflower particle.

In certain embodiments, the reaction solution is heated at a temperature of 150-250° C.

In a second aspect, provided herein is an electrode comprising the ruthenium-iron (RuFe) nanoflower particle described herein and a base electrode.

In a third aspect, provided herein is an electrochemical cell comprising: the electrode described herein; a counter electrode; optionally a reference electrode; and an electrolyte solution between and in contact with the electrode, the counter electrode, and optionally the reference electrode.

In a fourth aspect, provided herein is a method of producing ammonia, the method comprising: providing the electrochemical cell described herein, wherein the electrolyte solution comprises a substrate selected from the group consisting of a nitrate salt, a nitrite salt, nitric oxide, nitrogen (N₂), and mixtures thereof; and applying a potential between the electrode and the counter electrode resulting in the electrolytic reduction of the substrate thereby forming ammonia.

In certain embodiments, the potential is −0.3 to −0.65 volts vs reversible hydrogen electrode.

In certain embodiments, the nitrate salt is present in the electrolyte solution at a concentration of 0.01 to 0.1 M.

In certain embodiments, the method has a NH₃ Faradaic efficiency (FE) of 87.1%-92.9% at −0.10 and −0.65 V vs reversible hydrogen evolution.

In a fifth aspect, provided herein is a method of preparing the RuFe nanoflower particle described herein, the method comprising: contacting Ru₃(CO)₁₂, Fe(acac)₃, glucose, and citric acid in a solvent comprising oleylamine and n-octanol thereby forming a reaction solution and heating the reaction solution thereby forming the RuFe nanoflower particle.

In certain embodiments, the reaction solution is heated at a temperature of 150-300° C.

In certain embodiments, Ru₃(CO)₁₂ and Fe(acac)₃ are contacted in a molar ratio less than 1:1, respectively.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1. Synthesis and characterization of RuFe NFs. (A) Schematic illustration of the synthesis of RuFe NFs for NO₃RR. PEM, proton exchange membrane. (B and C) TEM (B) and HAADF-STEM (C) images of RuFe NFs. (D) High-resolution spherical aberration-corrected HAADF-STEM image of RuFe NFs. Inset: the corresponding FFT pattern of the selected area with the white dashed square in (D). (E to H) HAADF-STEM image (E) and the corresponding EDS elemental mappings (F-H) of RuFe NFs.

FIG. 2. X-ray spectral analysis of RuFe NFs. (A) XPS spectra of RuFe NFs, RuFe NDs and Ru NSs. (B and C) Normalized Ru K-edge XANES (B) and Fourier transform of k²-weighted EXAFS (C) spectra of RuFe NFs and RuFe NDs in reference to Ru foil and RuO₂ powder. (D and E) R space (D) and inverse Fourier transform (E) EXAFS fitting results of Ru K-edge for RuFe NFs, RuFe NDs and Ru foil, respectively. (F) Wavelet transform for the k²-weighted Ru K-edge EXAFS spectra of RuFe NFs, RuFe NDs and Ru foil, respectively.

FIG. 3. Electrocatalytic nitrate reduction performance of RuFe NFs. (A) LSV curves of RuFe NFs, RuFe NDs and Ru NSs in 0.5 M Na₂SO₄ with or without (w/o) 0.1 M NaNO₃. (B and C) NH₃ FE (B) and yield rate (C) of RuFe NFs, RuFe NDs and Ru NSs at various potentials. Inset: zoom-in graph for the low potentials. (D) The NH₃-to-NO₂⁻ ratio of RuFe NFs, RuFe NDs and Ru NSs at different potentials. (E) NMR spectra of the electrolytes after electrolysis using RuFe NFs at −0.30 V (vs RHE) without or with Na¹⁴NO₃ and Na¹⁵NO₃ as the feeding nitrogen sources. (F) The NH₃ FE and yield rate of RuFe NFs at −0.30 V (vs RHE) by UV-vis and NMR methods. (G) NH₃ FE and yield rate of RuFe NFs at −0.30 V (vs RHE) with different nitrate concentrations. (H) The consecutive recycling electrolysis test of RuFe NFs at −0.30 V (vs RHE).

FIG. 4. Theoretical calculations of electrochemical NO₃RR. (A and B) The 3D contour plots of electronic distributions near the Fermi level of (A) RuFe NFs and (B) RuFe NDs, respectively. (C and D) PDOS of (C) RuFe NFs and (D) RuFe NDs. (E and F) Site-dependent PDOS of (E) Ru-4d and (F) Fe-3d orbitals in RuFe NFs. (G and H) Site-dependent PDOS of (G) Ru-4d and (H) Fe-3d orbitals in RuFe NDs. (I) The adsorption energy comparisons of NO₃⁻ and H₂O on RuFe NFs and RuFe NDs. (J) The energy changes of NO₃RR on RuFe NFs and RuFe NDs. Dotted lines represent the energy levels for the desorption of formed NO₂⁻. (K) The reaction energy changes of HER on RuFe NFs and RuFe NDs.

FIG. 5. Rechargeable Zn—NO₃⁻ battery performance. (A) Open circuit potential of the RuFe NFs based Zn—NO₃⁻ battery in the rest period. (B) Discharging curve and the corresponding power density plot of the RuFe NFs based Zn—NO₃⁻ battery. (C) Discharging curves of RuFe NFs based Zn—NO₃⁻ battery under different current densities. (D) Photographs of an electronic timer powered by the RuFe NFs based Zn—NO₃⁻ battery for over 24 h. (E) The specific capacities of RuFe NFs based Zn—NO₃⁻ battery under the current densities of 1.0 and 2.5 mA mg_{cat}⁻¹. (F) Discharge-charge profiles of RuFe NFs based Zn—NO₃⁻ battery at a constant current density of 2.5 mA mg_{cat}⁻¹.

FIG. 6. (A, B) Low-magnification TEM images of RuFe NFs.

FIG. 7. A typical side-view HRTEM image of ultrathin RuFe NFs.

FIG. 8. The EDS spectrum of RuFe NFs. Inset: a table demonstrating the weight ratio and atomic ratio between Ru and Fe.

FIG. 9. XRD pattern of the as-synthesized RuFe NFs, in comparison with that of the standard hcp Ru (JCPDS 06-0663).

FIG. 10. (A, B) The HAADF-STEM image (A) and the corresponding EDS line scanning profiles (B) of RuFe NFs.

FIG. 11. (A-H) TEM images of intermediate products for RuFe NFs at different reaction times: (A, B) 12 h, (C, D) 24 h, (E, F) 36 h and (G, H) 72 h.

FIG. 12. (A-D) The EDS spectra of RuFe NFs at different reaction times: (A) 12 h, (B) 24 h, (C) 36 h, and (D) 72 h.

FIG. 13. (A-D) TEM images (A, C) and EDS spectra (B, D) of the products obtained with RuCl₃·xH₂O (A, B) and Ru(acac)₃ (C, D) as the Ru precursors.

FIG. 14. (A-D) TEM images of the products obtained with different Ru/Fe atomic feeding ratios: (A, B) 7/3 and (C, D) 3/7.

FIG. 15. (A-D) TEM images of the products obtained by changing citric acid to (A, B) salicylic acid and (C, D) tricarballylic acid.

FIG. 16. (A, B) TEM images of the products obtained by changing n-octanol to (A) 1,4-butanediol or (B) benzyl alcohol.

FIG. 17. (A, B) TEM (A) and HRTEM (B) images of Ru NSs. Inset of (B): The corresponding FFT pattern of selected region with white dashed square. (C) SAED pattern of Ru NSs. (D) XRD pattern of Ru nanosheets, in comparison with that of the standard hcp Ru (JCPDS 06-0663).

FIG. 18. (A-D) TEM images (A, B), SAED pattern (C) and HRTEM image (D) of RuFe NDs. Inset of (D): The corresponding FFT pattern of selected region with white dashed square. (E-H) HAADF-STEM image (E) and the corresponding EDS elemental mappings (F-H) of RuFe NDs.

FIG. 19. The EDS spectrum of RuFe NDs. Inset: a table demonstrating the weight ratio and atomic ratio between Ru and Fe.

FIG. 20. The XRD pattern of as-synthesized RuFe NDs, in comparison with that of the standard hcp Ru (JCPDS 06-0663).

FIG. 21. (A, B) High-resolution Fe 2p XPS spectra of (A) RuFe NFs and (B) RuFe NDs.

FIG. 22. The UV-vis calibration curve of NH₃ using different concentrations of NH₄Cl solutions as standards. (A, B) UV-vis curves of assays with NH₄⁺ ions (A) and linear fitting results of the calibration curves (B).

FIG. 23. The UV-vis calibration curve of NO₂ using different concentrations of KNO₂ solutions as standards. (A, B) UV-vis curves of assays with NO₂ ions (A) and linear fitting results of the calibration curves (B).

FIG. 24. (A-F) The LSV (A-C) and chronoamperometric (D-F) curves of RuFe NFs with different loading amounts: (A, D) 100 g, (B, E) 200 g, and (C, F) 400 g.

FIG. 25. (A-D) Comparison of the (A, C) NH₃ FE, (B) NO₂ FE, and (D) the NH₃ yield rate with different loading amounts of RuFe NFs at various potentials.

FIG. 26. (A, B) The chronoamperometric curves of (A) Ru NSs and (B) RuFe NDs at various potentials.

FIG. 27. The partial current densities of NH₃ for Ru NSs, RuFe NDs and RuFe NFs at different potentials.

FIG. 28. (A, B) NO₂ FE (A) and yield rate (B) of RuFe NFs, RuFe NDs and Ru NSs at various potentials.

FIG. 29. (A-C) Cyclic voltammetry (CV) profiles of (A) Ru NSs, (B) RuFe NDs and (C) RuFe NFs at the sweep rates of 100, 120, 140, 160, 180, 200 and 220 mV s-1. (D) The relationship between the current density and the scan rate for Ru NSs, RuFe NDs and RuFe NFs.

FIG. 30. (A, B) The chronoamperometric curves (A) and the yield rate of NH₃ (B) after electrolysis at −0.30 V (vs RHE) with or without nitrate.

FIG. 31. (A) The ¹H NMR spectra of ¹⁴NH₄⁺ with different ¹⁴NH₄Cl concentrations using C₄H₄O₄ as internal standards. (B) The calibration curve of integral area (¹⁴NH₄⁺/C₄H₄O₄) against ¹⁴NH₄⁺ concentration.

FIG. 32. (A) The ¹H NMR spectra of ¹⁵NH₄⁺ with different ¹⁵NH₄Cl concentrations using C₄H₄O₄ as internal standards. (B) The calibration curve of integral area (¹⁵NH₄⁺/C₄H₄O₄) against ¹⁵NH₄⁺ concentration.

FIG. 33. (A-C) The chronoamperometric curves of RuFe NFs with (A) 0.010 M NaNO₃, (B) 0.050 M and (C) 0.075 M NaNO₃ at various potentials.

FIG. 34. (A-F) LSV curves (A), NH₃ FE (B), NH₃ yield rate (C), NO₂ FE (D), NO₂ yield rate (E) and the ratio between NH₃ and NO₂ (F) for RuFe NFs with different NaNO₃ concentrations at various potentials.

FIG. 35. (A, B) Chronopotentiometry curves of (A) RuFe NDs and (B) RuFe NFs at −0.30 V (vs RHE). The electrolytes were refreshed after 720 mins. The dashed circles indicate that the current density recovers to the same value after refreshing the electrolytes.

FIG. 36. The LSV curves of RuFe NFs after electrolysis for different times.

FIG. 37. (A-B) The ¹H NMR spectra for the electrolytes under different electrolysis times with (A) RuFe NDs and (B) RuFe NFs.

FIG. 38. The NH₃ FE and yield rate obtained by both NMR and UV-vis methods of the electrolytes after electrolysis at −0.30 V (vs RHE) for different times.

FIG. 39. The chronoamperometry curves of RuFe NFs during the consecutive 20 cycles at −0.30 V (vs RHE).

FIG. 40. The FE of NO₂ on RuFe NFs during the consecutive electrolysis of 20 cycles at −0.30 V (vs RHE).

FIG. 41. (A, B) TEM image (A) and EDS spectrum (B) of RuFe NFs after the catalytic stability test. Inset of (B): a table demonstrating the weight ratio and atomic ratio between Ru and Fe.

FIG. 42. Discharging curves of Zn—NO₃⁻ battery and the corresponding power density plots using RuFe NFs as the cathode catalysts.

FIG. 43. A summary of the Ru K-edge EXAFS fitting results of RuFe NFs, RuFe NDs, Ru foil and RuO₂. Note: Fittings were obtained using k²-weighted R-space spectra with a k-range of 3.0-12 Å⁻¹ and a R-range of 1.0-3.0 Å; R is the interatomic distance (the bond length between center atoms and surrounding coordination atoms); C.N. is the coordination number; σ² is the Debye-Waller factor (a measure of thermal and static disorder in absorber-scatterer distances); ΔE₀ is the edge-energy shift (the difference between the zero kinetic energy value of the sample and that of the theoretical model) used to align the theoretical calculated spectrum to the energy grid of the measured spectrum; The uncertainty of fitting parameters: C.N., ±20%, R, ±1%; σ², ±20%, ΔE₀, ±20%. R factor is used to evaluate the goodness of the fitting. *These values were fixed during the EXAFS fitting, based on the known structures of Ru foil.

FIG. 44. The comparison of electrochemical nitrate reduction performance of RuFe NFs with other reported heterogeneous electrocatalysts.

### DETAILED DESCRIPTION

### Definitions

Throughout the present disclosure, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the present invention.

Furthermore, throughout the present disclosure and claims, unless the context requires otherwise, the word “include” or variations such as “includes” or “including”, will be understood to imply the inclusion of a stated integer or group of integers, but not the exclusion of any other integer or group of integers.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10%, ±7%, ±5%, ±3%, ±1%, or ±0% variation from the nominal value unless otherwise indicated or inferred.

The term “substantially crystalline” refers to compositions or compounds with at least 70% by weight, at least 75% by weight, at least 80% by weight, at least 85% by weight, at least 90 by weight, at least 95% by weight, at least 96% by weight, at least 97% by weight, at least 98% by weight, at least 99% by weight, at least 99.5% by weight, or more of the composition or compound is present in crystalline form. The compositions or compounds can exist in a single crystalline form or more than one crystalline form. In certain embodiments, the composition or compound has at least 70% by weight, at least 75% by weight, at least 80% by weight, at least 85% by weight, at least 90 by weight, at least 95% by weight, at least 96% by weight, at least 97% by weight, at least 98% by weight, at least 99% by weight, at least 99.5% by weight, or more of the composition or compound present in a single crystalline form. The degree (%) of crystallinity may be determined by the skilled person using X-ray powder diffraction (XRPD). Other techniques, such as solid-state NMR, FT-IR, Raman spectroscopy, differential scanning calorimetry (DSC) and microcalorimetry, may also be used.

As used herein, the term “nanoflowers” refers to particles exhibiting a characteristic three-dimensional flowerlike morphology.

Provided herein is a RuFe nanoflower particle comprising a plurality of RuFe nanosheets, wherein the plurality of RuFe nanosheets are in a form of a nanoflower. In certain embodiments, each of the plurality of RuFe nanosheets are substantially crystalline.

The RuFe nanoflower particle can range in size between 50-400 nm, 50-350 nm, 50-300 nm, 50-250 nm, 100-250 nm, 150-250 nm, 175-225 nm, 180-210 nm, 180-200 nm, 185-195 nm, 50-200 nm, 100-200 nm, 150-200 nm, or 100-150 nm. A plurality of the RuFe nanoflower particles can have an average size between 50-400 nm, 50-350 nm, 50-300 nm, 50-250 nm, 100-250 nm, 150-250 nm, 175-225 nm, 180-210 nm, 180-200 nm, 185-195 nm, 50-200 nm, 100-200 nm, 150-200 nm, or 100-150 nm. In certain embodiments, a plurality of the RuFe nanoflower particles have an average size of about 190 nm.

Each of the plurality of RuFe nanosheets can have an average thickness of 0.5-5, 0.5-4.5, 0.5-4, 0.5-3.5, 0.5-3, 1-3, 1-2.5, 1.5-2.5, 1.5-2.0, 1-2, 1-1.5, 1.3-2.3, 1.4-2.2, 1.5-2.1, 1.6-2, or 1.7-1.9 nm. In certain embodiments, the each of the plurality of RuFe nanosheets have an average thickness of about 1.8 nm.

Depending on the reaction conditions used to prepare the RuFe nanoflower particle, the atomic ratio of Ru to Fe in the RuFe nanoflower particle can range from 46:54 to 52:48; 46.5:53.5 to 51.5:48.5; 47:53 to 51:49; 47.5:52.5 to 50.5:49.5; 48:52 to 50:50; 48.5:51.5 to 49.5:50.5; 49:51

The atomic ratio of Ru to Fe in the RuFe nanoflower particle can range from 46:54 to 52:48; 46.5:53.5 to 51.5:48.5; 47:53 to 51:49; 47.5:52.5 to 50.5:49.5; 48:52 to 50:50; 48.5:51.5 to 49.5:50.5; 49:51 to 50:50; 48.25:51.75 to 49.75:50.25; 48.5:51.5 to 51.5:48.5; or 48.75 to 51.25 to 51.25 to 49.75, respectively. In certain embodiments, the atomic ratio of Ru to Fe in the RuFe nanoflower particle is about 49:51, respectively. A plurality of the RuFe nanoflower particles can have an average atomic ratio of Ru to Fe in the plurality of RuFe nanoflower particles from 46:54 to 52:48; 46.5:53.5 to 51.5:48.5; 47:53 to 51:49; 47.5:52.5 to 50.5:49.5; 48:52 to 50:50; 48.5:51.5 to 49.5:50.5; 49:51 to 50:50; 48.25:51.75 to 49.75:50.25; 48.5:51.5 to 51.5:48.5; or 48.75 to 51.25 to 51.25 to 49.75, respectively. In certain embodiments, a plurality of the RuFe nanoflower particles have an average atomic ratio of Ru to Fe in the plurality of RuFe nanoflower particles of about 49:51, respectively.

The RuFe nanoflower particle or a plurality of the RuFe nanoflower particles can have an electrochemically active surface area of 200-267.5 cm², 225267.5 cm², 250-267.5 cm², or 260-267.5 cm². In certain embodiments, the RuFe nanoflower particle or a plurality of the RuFe nanoflower particles have an electrochemically active surface area of about 267.5 cm².

The present disclosure also provides an electrode comprising a base electrode and the RuFe nanoflower particle or a plurality of the RuFe nanoflower particles described herein. In certain embodiments, the RuFe nanoflower particle or the plurality of RuFe nanoflower particles are coated on a surface of the base electrode. The base electrode can be an inert electrode such as a GCE, a graphite electrode, an indium tin oxide (ITO) electrode, a fluorine doped tin oxide (FTO) electrode, carbon paper electrode, carbon fiber electrode, polycarbonate track etch (PCTE)-based electrode, or a titanium-based electrode. In certain embodiments, the electrode is a cathode.

The electrode can optionally comprise a binder. The binder may optionally be cured to further bind the RuFe nanoflower particle or a plurality of the RuFe nanoflower particles with the base electrode and can increase the conductivity of electrode. Typical binders include, for example polyvinylidene fluoride (PVDF), polyvinyl alcohol (PVA), starch, sodium alginate, hydroxypropyl cellulose, carboxymethyl cellulose (CMC), regenerated cellulose, polyvinylpyrrolidone, polyimide, polyamideimide, polyethylene, polypropylene, an ethylene-propylene-diene terpolymer (EPDM), a sulfonated EPDM, a styrene-butadiene rubber, polytetrafluoroethylene (PTFE), a polyacrylic polymer, and combinations thereof. In certain embodiments, the binder is PVA.

The present disclosure also provides an electrochemical cell comprising: the electrode described herein; a counter electrode (or counter/reference electrode); optionally a reference electrode (e.g., in a three-electrode system); and an electrolyte solution between and in contact with the electrode, the counter electrode, and optionally the reference electrode. In certain embodiments, the electrolyte solution comprises an aqueous solution.

A counter electrode refers to an electrode paired with the working electrode, through which passes a current equal in magnitude and opposite in sign to the current passing through the working electrode. The counter electrode can include counter electrodes which also function as reference electrodes (i.e., a counter/reference electrode). Any suitable counter electrode known in the art can be used in connection with the methods described herein. For example, the counter electrode can comprise carbon (e.g., highly oriented pyrolytic graphite), a metal (e.g., platinum), an alloy (e.g., stainless steel), glassy carbon, a conductive polymer, or the like.

The reference electrode can be selected from a standard hydrogen electrode, calomel electrode, copper-copper (II) sulfate electrode, silver chloride electrode, palladium-hydrogen electrode, mercury-mercurous sulfate electrode, and the like.

In certain embodiments, the electrolyte comprises a nitrate salt. The type of nitrate salt is not particularly limited and can be any nitrate salt that is at least partially soluble in the electrolyte solution. The nitrate salt can include one or more cations selected from alkali metals, such as lithium, sodium, potassium, rubidium, and cesium; alkaline earth metals, such as beryllium, magnesium, calcium, strontium, and barium; Group 3-12 transition metals; and NR₄⁺, wherein R is independently for each instance selected from hydrogen and C₁-C₆ alkyl. In certain embodiments, the nitrate salt is selected from the group consisting of LiNO₃, NaNO₃, KNO₃, Ca(NO₃)₂, Mg(NO₃)₂, NH₄NO₃, CsNO₃, and mixtures thereof.

The concentration of the nitrate salt in the electrolyte solution can range from 0.01 to 1 M, 0.01 to 0.9 M, 0.01 to 0.8 M, 0.01 to 0.7 M, 0.01 to 0.6 M, 0.01 to 0.5 M, 0.01 to 0.4 M, 0.01 to 0.3 M, 0.01 to 0.2 M, 0.01 to 0.1 M, 0.05 to 0.1 M, 0.075 to 0.1 M, 0.01 to 0.075 M, 0.01 to 0.05 M, or 0.05 to 0.75 M.

In certain embodiments, the electrolyte solution further comprises one or more supporting electrolytes. In certain embodiments, the supporting electrolyte is an alkali metal (e.g., lithium, sodium, potassium, rubidium, and cesium), alkaline earth metal (e.g., beryllium, magnesium, calcium, strontium, and barium), or ammonium salt of a halide, acetate, carbonate, perchlorate, phosphate, monohydrogen phosphate, dihydrogen phosphate, or sulfate. Exemplary supporting electrolytes include, but are not limited to, LiClO₄, NaClO₄, KClO₄, Na₂SO₄, K₂SO₄, NaCl, KCl, MgCl₂, NH₄Cl, (NH₄)₂SO₄, Na₃PO₄, K₃PO₄, MgSO₄, Na₂CO₃, K₂CO₃, MgCO₃, NaOH, and KOH.

Also provided herein is a method of producing ammonia gas, the method comprising providing the electrochemical cell described herein, wherein the electrolyte solution comprises a substrate selected from the group consisting of a nitrate salt, a nitrite salt, nitric oxide, nitrogen (N₂), and mixtures thereof; and applying a potential between the electrode and the counter electrode resulting in the electrolytic reduction of the substrate thereby forming ammonia.

The potential applied to the electrode and the counter electrode can range from −0.1 to 1 volts. In certain embodiments, the potential applied to the electrode and the counter electrode can range from −0.1 to −0.9 volts, −0.1 to −0.8 volts, −0.1 to −0.7 volts, −0.1 to −0.6 volts, −0.1 to −0.5 volts, −0.1 to −0.4 volts, −0.1 to −0.3 volts, −0.1 to −0.2 volts, −0.2 to −0.9 volts, −0.3 to −0.9 volts, −0.4 to −0.9 volts, −0.5 to −0.9 volts, −0.6 to −0.9 volts, −0.7 to −0.9 volts, −0.8 to −0.9 volts, −0.2 to −0.8 volts, −0.3 to −0.7 volts, −0.4 to −0.6 volts, −0.5 to −0.6 volts, −0.4 to −0.5 volts, −0.3 to −0.65 volts, −0.4 to −0.65 volts, −0.5 to −0.65 volts, −0.55 to −0.65 volts, or −0.6 to −0.65 volts.

The electrochemical cell provided herein can reduce nitrate to ammonia with a NH₃-to-NO₂⁻ ratio between 34.4-211.8 to 1, 65.4-211.8 to 1, 73.8-211.8 to 1, 100-211.8 to 1, 175-211.8 to 1, or 200-211.8 to 1. In certain embodiments, the electrochemical cell can generate ammonia at a yield rate of 9.90 mg h⁻¹ mg_{cat}⁻¹ to 38.68 mg h⁻¹ mg_{cat}⁻¹ at −0.65 volts vs RHE at a concentration of nitrate between 0.01-0.1 M.

The method can have a NH₃ Faradaic efficiency (FE) of 92.9% and 85.1% at −0.10 and −0.65 V vs reversible hydrogen evolution, respectively.

The RuFe nanoflower particle described herein can be prepared by a solvothermal method comprising: contacting Ru₃(CO)₁₂, Fe(acac)₃, glucose, and citric acid in a solvent comprising oleylamine and n-octanol thereby forming a reaction solution and heating the reaction solution thereby forming the RuFe nanoflower particle.

Ru₃(CO)₁₂ and Fe(acac)₃ can be contacted in a molar ratio of Ru₃(CO)₁₂ and Fe(acac)₃ equal to or less than 3:2, 1:1, 2:3, or 3:7, respectively. In certain embodiments, Ru₃(CO)₁₂ and Fe(acac)₃ can be contacted in a molar ratio of Ru₃(CO)₁₂ and Fe(acac)₃ of about 3:7, respectively.

The reaction solution can be heated at a temperature of 150-400° C., 150-350° C., 150-300° C., 150-250° C., or 175-225° C. In certain embodiments, the reaction solution is heated at about 200° C. The reaction solution can be heated for a period of 2 hours to 144 hours, 12 hours to 144 hours, 12 hours to 120 hours, 12 hours to 96 hours, 12 hours to 72 hours, 24 hours to 72 hours, or 30 hours to 54 hours. In certain embodiments, the reaction solution is heated for a period of about 48 hours.

In certain embodiments, the step of heating the reaction solution is conducted under autogenic pressure, i.e., pressure generated as a result of heating in a closed system. Alternatively or additionally, the pressure can be applied externally, e.g., by mechanical means. In certain embodiments, the step of heating the reaction solution is conducted at a pressure of 0.1 to 10 MPa or 0.1 to 1 MPa.

### Results

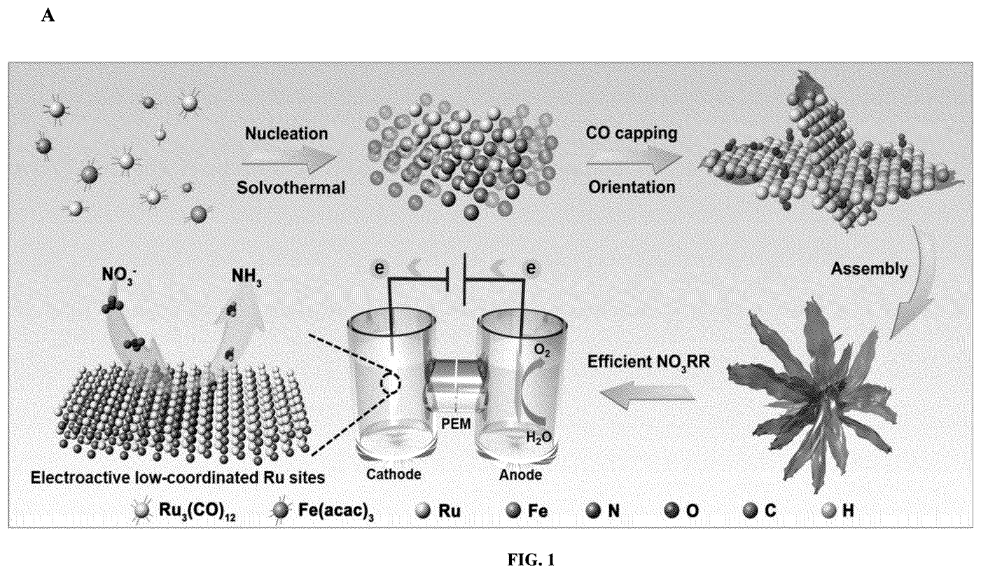

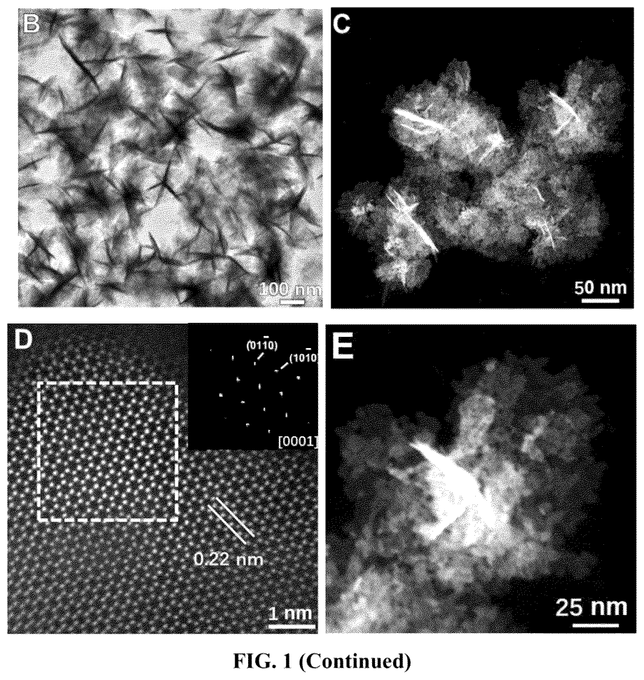

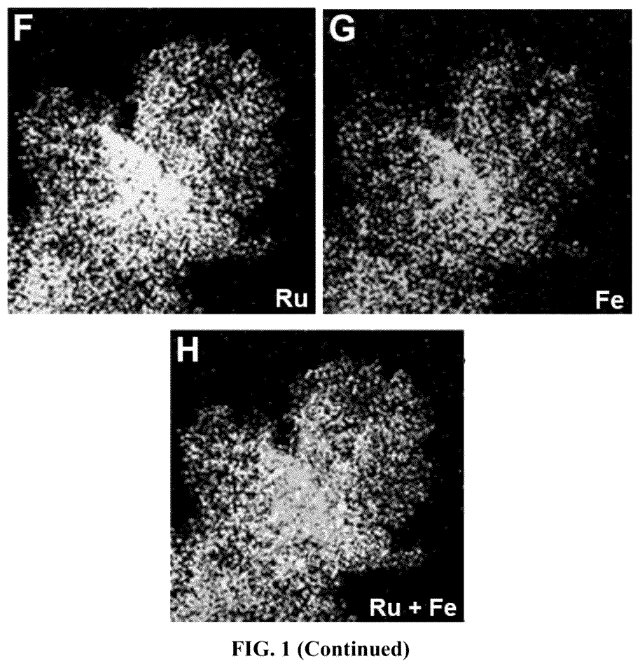

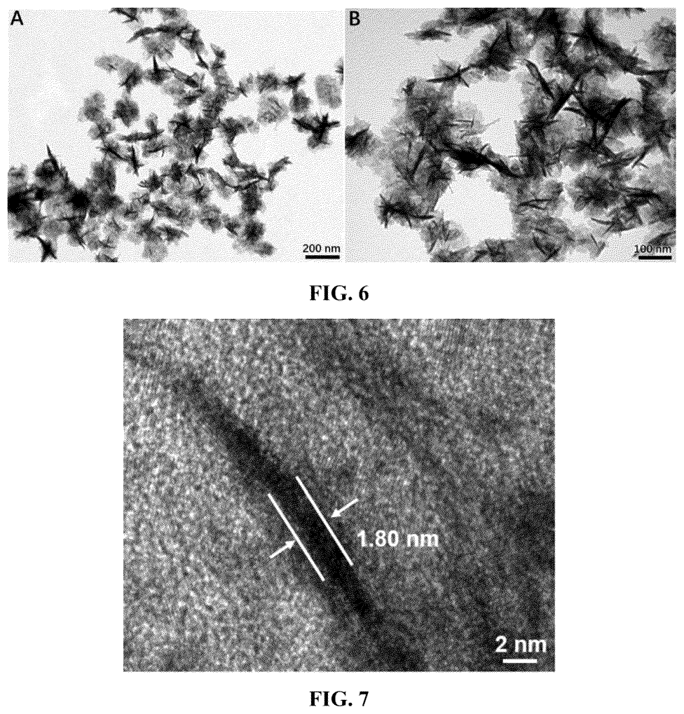

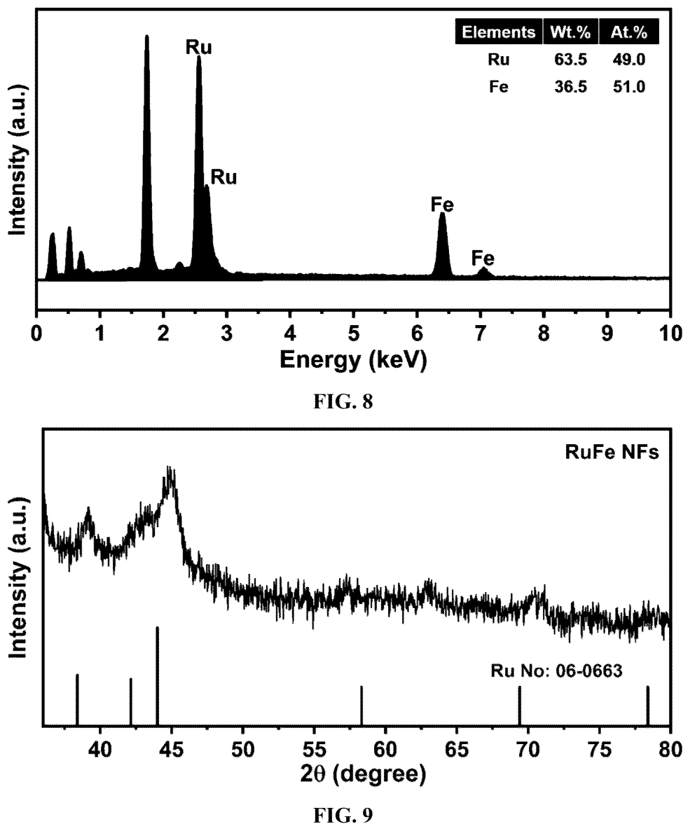

Synthesis and characterization of RuFe NFs. In a typical experiment, the RuFe NFs were synthesized by a facile solvothermal method with triruthenium dodecacarbonyl (Ru₃(CO)₁₂) and iron(III) acetylacetonate (Fe(acac)₃) as the metal precursors, glucose and citric acid as the reducing agents, and oleylamine and n-octanol as the solvents (FIG. 1A). As illustrated by the transmission electron microscopy (TEM) (FIG. 1B and FIG. 6), high-resolution TEM (HRTEM) (FIG. 7) and high-angle annular dark-field scanning TEM (HAADF-STEM, FIG. 1C) images, the obtained RuFe NFs show three-dimensional (3D) flower-like structure assembled by ultrathin nanosheets. The energy-dispersive X-ray spectroscopy (EDS) results display that the atomic ratio of Ru:Fe is 49.0:51.0 (FIG. 8). The powder X-ray diffraction (XRD) pattern of RuFe NFs reveals that the formation of RuFe alloy structure with a hexagonal close-packed (hcp) phase (FIG. 9). The high-resolution spherical aberration-corrected STEM image was taken to further confirm the crystal phase of the obtained nanostructures (FIG. 1D). The atomic arrangement reveals the hcp phase of RuFe NFs, which is also identified by both the fast Fourier transform (FFT) pattern along the [0001]ₕ zone axis. Moreover, an interplanar spacing was measured to be 0.22 nm, corresponding to the (1010) facet of hcp RuFe alloy. Due to the introduction of Fe, the measured lattice spacing of RuFe NFs is smaller than that of pure Ru, consistent with the positive shift of XRD pattern compared with that of the standard Ru (0.9). Besides, the EDS line scanning and elemental mappings corroborate the uniform distribution of Ru and Fe over the whole structure of RuFe NFs (FIG. 1 E-H and FIG. 10).

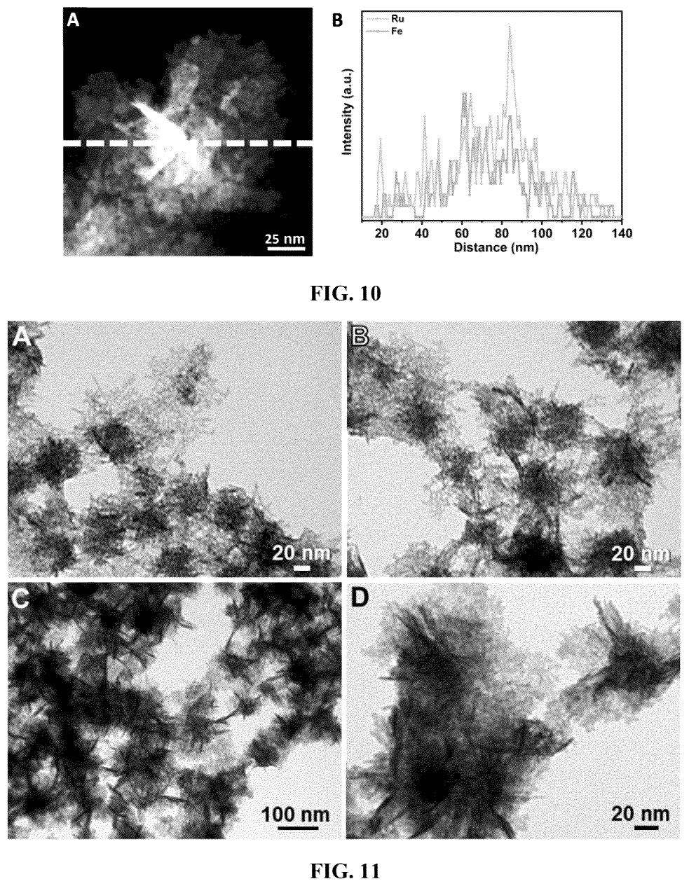

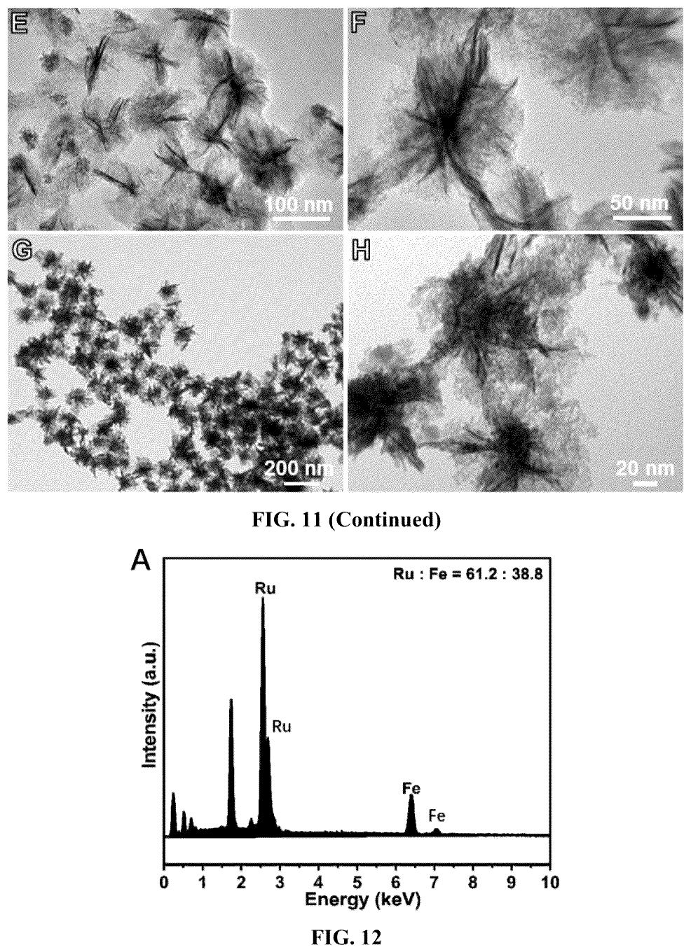

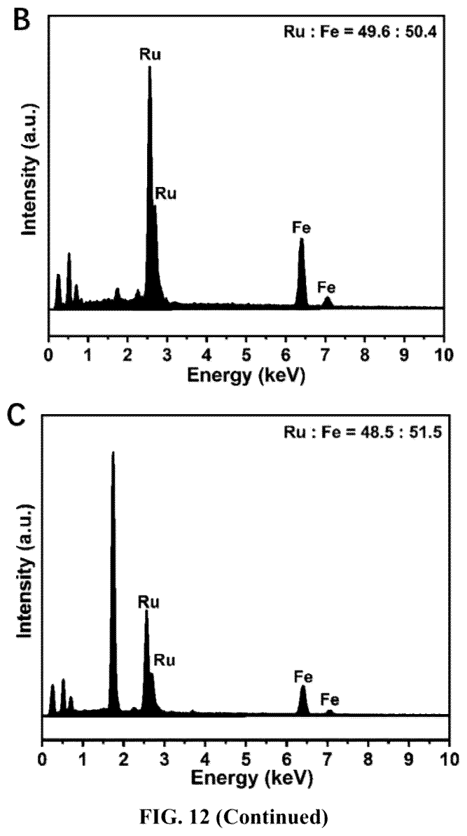

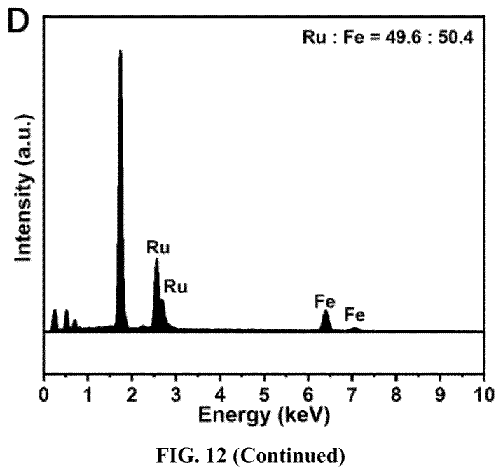

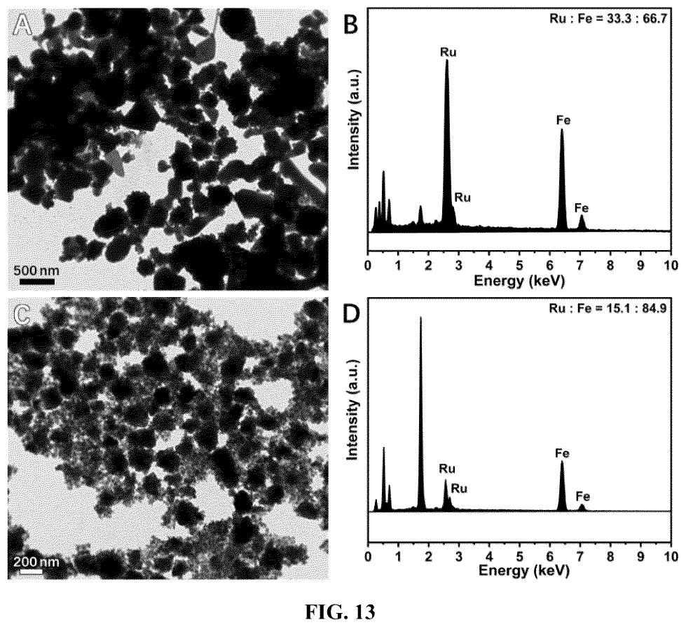

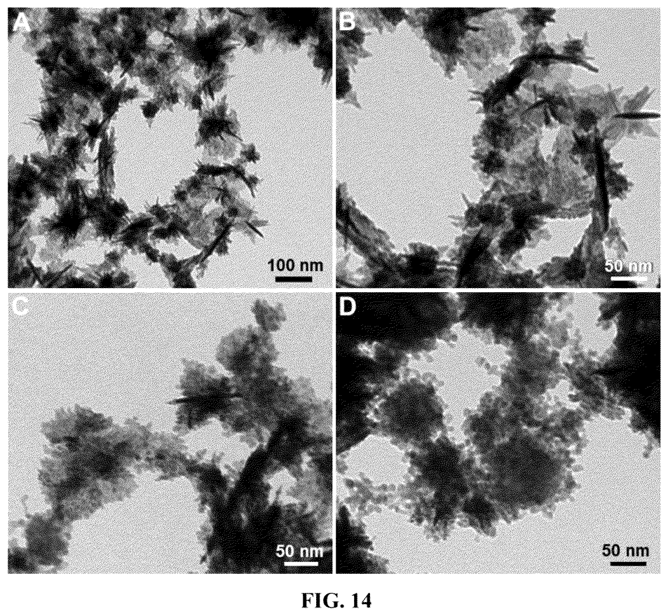

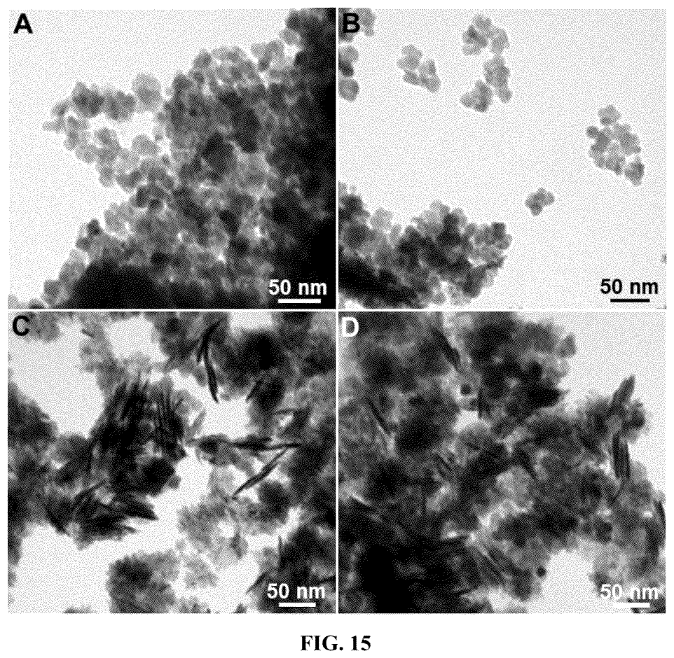

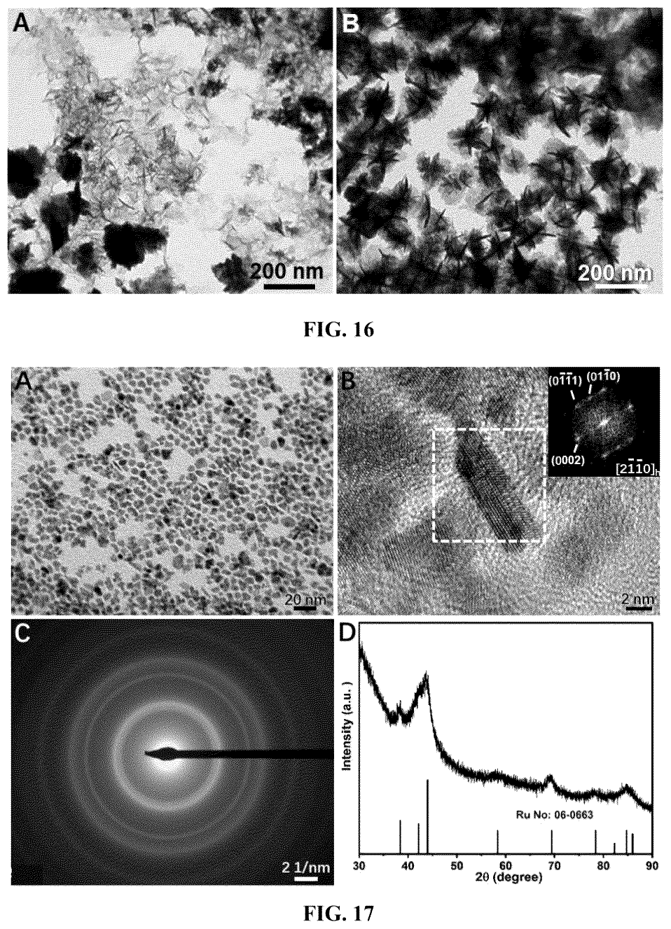

The time-dependent experiments were conducted to further investigate the formation and growth mechanisms of the assembled RuFe NFs. At the reaction time of 12 h, the RuFe nanowires with Ru/Fe atomic ratio of 61.2/38.8 were formed (FIGS. 11 A and B and 12A). With the increase of reaction time to 24 h, the size of the nanowires became large and assembled into nanoflowers with the Ru/Fe atomic ratio of 49.6/50.4 (FIGS. 11 C and D and 12B). The nanoflowers assembled with nanosheets were formed when the reaction time was further increased from 24 h to 72 h (FIGS. 6 and 11E-H), and the Ru/Fe atomic ratio changed and maintained at about 49.0/51.0 (FIGS. 8 and 12 C and D). Based on these observations, it was inferred that the Ru-rich RuFe alloy nanowires are firstly obtained, followed by the merging of nanowires and enrichment of Fe in the alloy nanostructures, and finally the nanoflowers assembled with nanosheets are generated. It was found that the usage of Ru₃(CO)₁₂ as the Ru precursor is essential to the formation of RuFe NFs. Only nanoparticles or nanodendrites were obtained when replacing Ru₃(CO)₁₂ with RuCl₃·xH₂O or Ru(acac)₃ and keeping other reaction conditions the same (FIG. 13). Notably, the atomic feeding ratio of Ru and Fe can also significantly affect the final morphology of RuFe nanostructures (FIG. 14). Besides the reaction time, the Ru precursor and the atomic feeding ratio, it was also found that citric acid and n-octanol play a very critical role in controlling the morphology. If the citric acid was replaced by salicylic acid or tricarballylic acid, only nanoparticles or small nanosheets were obtained (FIG. 15). When 1,4-butanediol and benzyl alcohol were used as the solvent rather than n-octanol, the nanosheet morphology can be formed but the purity or uniformity is very low (FIG. 16).

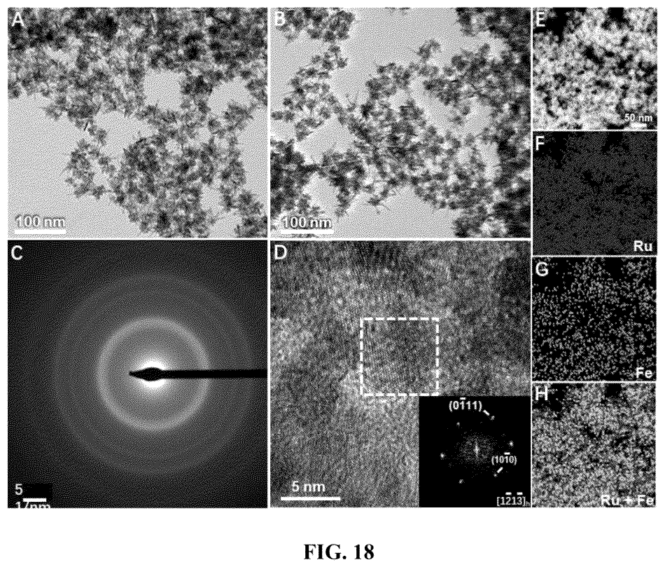

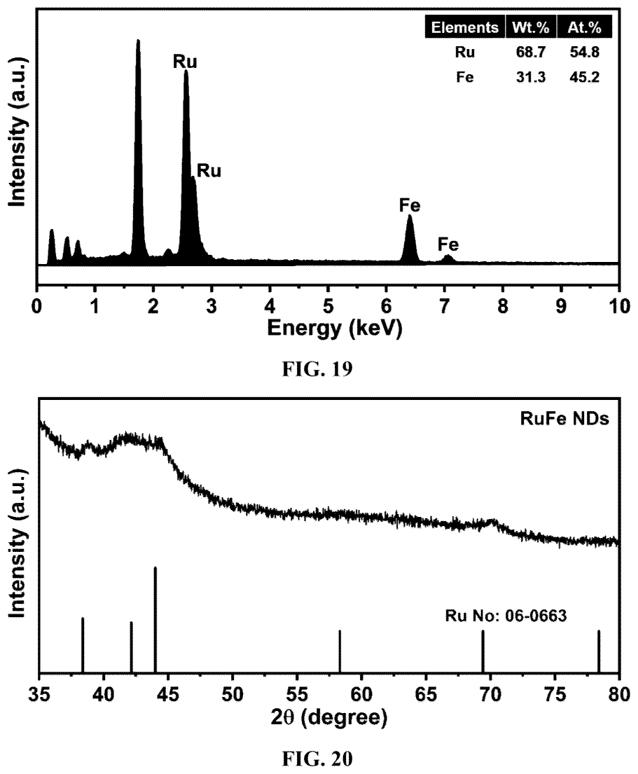

Ru nanosheets (NSs) and RuFe nanodendrites (NDs) were also synthesized as control samples. In a typical synthesis, 8 mg of Ru₃(CO)₁₂ and 13.6 mg of Fe(acac)₃ were added into 5 mL of OAm. After ultrasonication for around 10 mins, it was transferred to the Teflon-lined autoclave (25 mL capacity), and heated from room temperature to 220° C. and kept at this temperature for 14 h. The final products were collected by centrifugation and washed three times with 3 mL of the mixture of ethanol and hexane (v/v=1/1). The obtained RuFe NDs were re-dispersed into ethanol for further use. The obtained Ru NSs adopt the typical hcp phase, which is proved by the TEM, HRTEM, FFT, selected-area electron diffraction (SAED) and XRD patterns (FIG. 17). The typical TEM images of as-obtained RuFe NDs are shown in FIGS. 18 A and B. Importantly, the SAED pattern, HRTEM image and corresponding FFT pattern indicate the hcp phase of RuFe NDs (FIGS. 18 C and D). The STEM image and corresponding EDS elemental mappings reveal the homogeneous distribution of Ru and Fe in the RuFe NDs (FIG. 18 E-H). Importantly, the Ru/Fe atomic ratio of RuFe NDs was measured to be 54.8/45.2 (FIG. 19), which is similar to that of RuFe NFs. Furthermore, the hcp phase of RuFe NDs was further confirmed by the XRD pattern (FIG. 20).

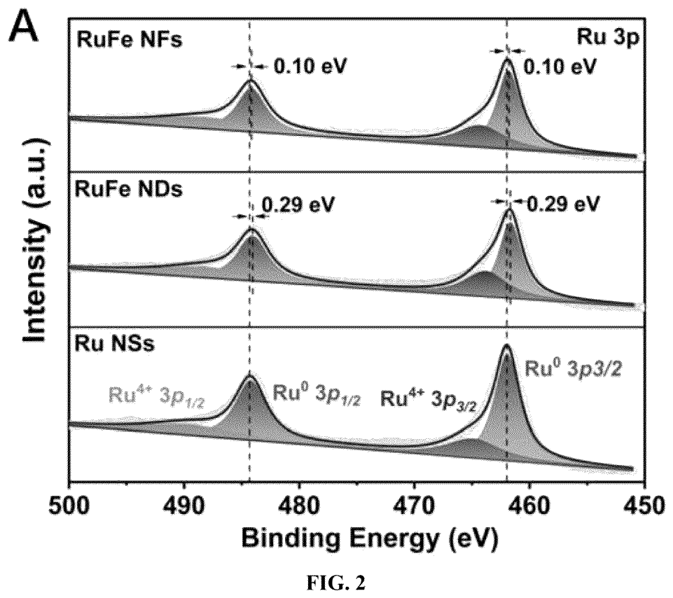

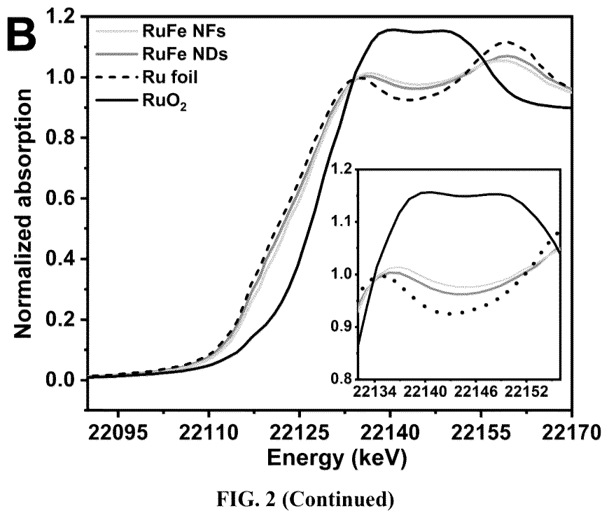

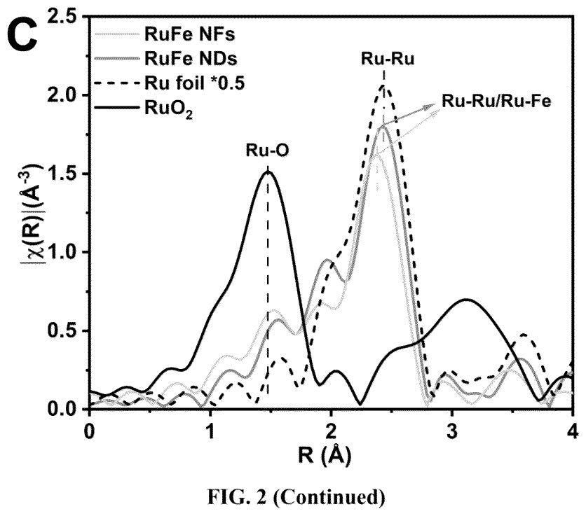

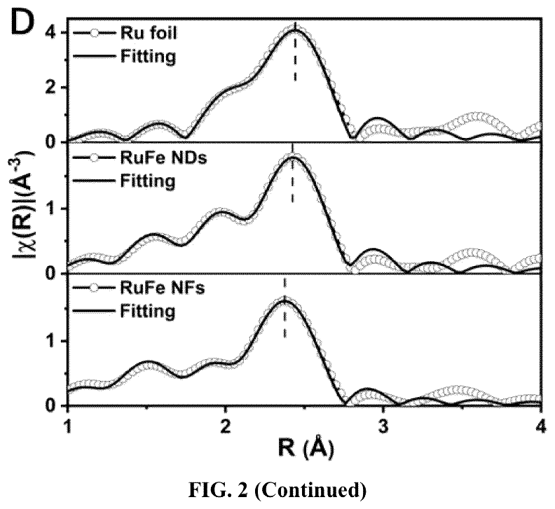

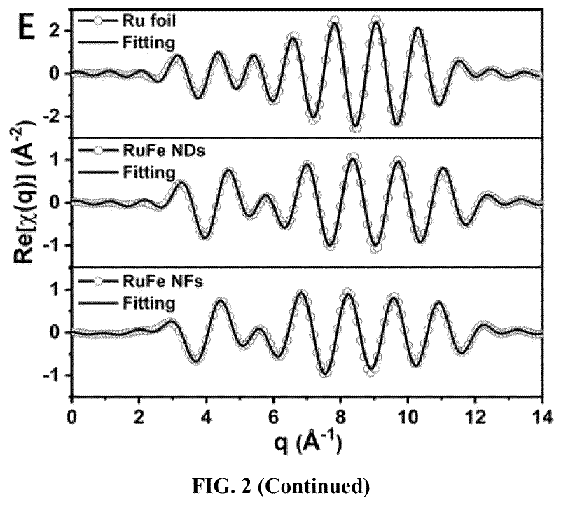

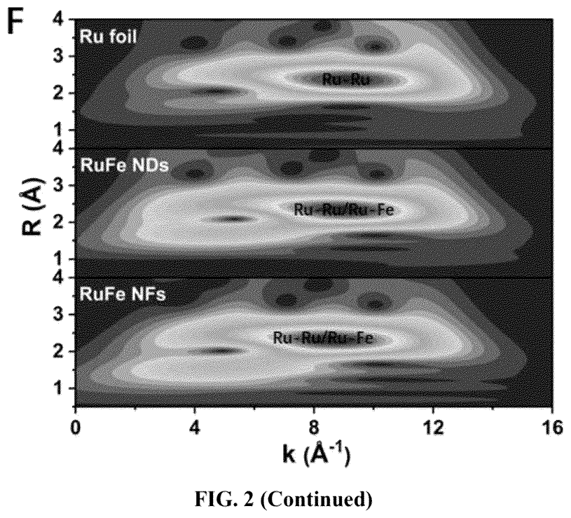

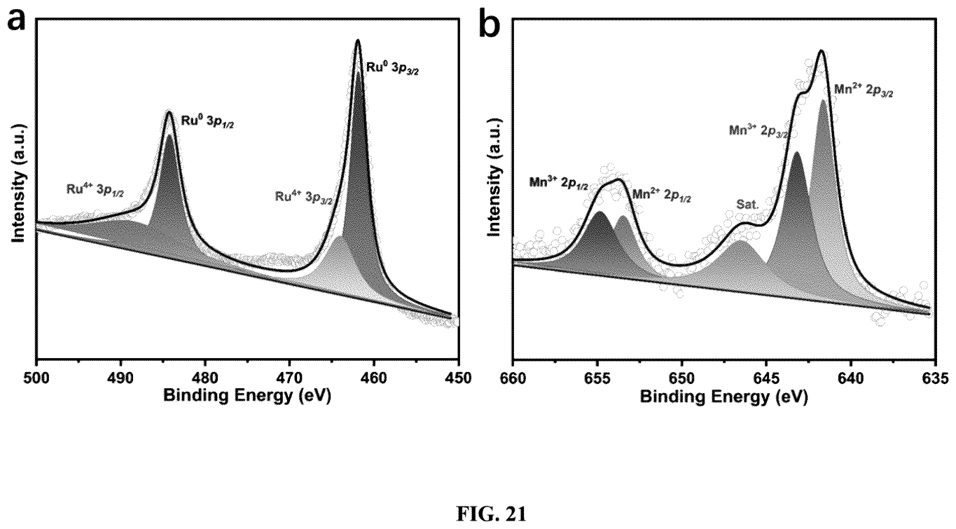

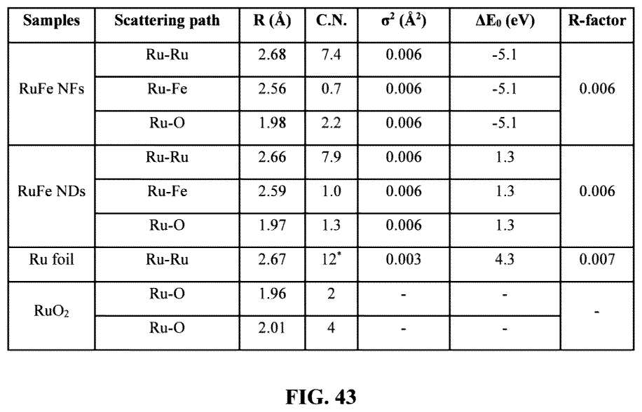

X-ray spectral analysis. X-ray photoelectron spectroscopy (XPS) was used to investigate the electronic structure of RuFe NFs. FIG. 2A shows the high-resolution Ru 3p XPS spectrum of RuFe NFs, along with those of Ru NSs and RuFe NDs. The peaks located at about 461.99 eV and 484.32 eV are attributed to Ru⁰ 3p_{3/2} and Ru⁰3p_{1/2}, respectively. Notably, the position of Ru⁰ peaks for RuFe NDs and RuFe NFs negatively shifted by around 0.29 eV and 0.10 eV compared with that of Ru NSs, respectively, which is ascribed to the electron transfer effect between Ru and Fe. The above results suggest that the electron density of Ru in RuFe NFs is higher than that of Ru NSs but lower than that of RuFe NDs. The high-resolution Fe 2p XPS spectra of RuFe NFs and RuFe NDs demonstrate the presence of metallic Fe⁰ and Fe^{x+} (x=2 or 3) in the products (FIG. 21), indicating the electron transfer and a certain extent of surface oxidation. Furthermore, X-ray absorption near-edge structure (XANES) and the extended X-ray absorption fine structure (EXAFS) spectroscopies were utilized to determine the electronic structures and coordination environments of Ru atoms in RuFe NFs and RuFe NDs. The normalized XANES spectra show that the white line intensities of RuFe NFs and RuFe NDs are slightly higher than that of Ru foil but far lower than that of RuO₂ powder (FIG. 2B), suggesting that the Ru atoms mainly exist in the metallic state for both RuFe NFs and RuFe NDs. In addition, the slightly lower intensity of RuFe NDs compared to RuFe NFs suggests the higher electron density of Ru, which is well consistent with the XPS results. The Fourier transforms of EXAFS spectra were further analyzed to provide the information on local structure of Ru atoms (FIG. 2 C-E). As shown in FIGS. 2 C and D, there is a dominant peak at around 2.4 A for RuFe NFs, RuFe NDs and Ru foil, which is ascribed to the Ru—Ru or Ru—Fe scattering paths. Moreover, RuFe NFs show a smaller Ru—Ru/—Fe bond length than those of RuFe NDs and Ru foil. As shown in FIG. 43, the Ru—Fe bond length (2.56 Å) of RuFe NFs is shorter than that of RuFe NDs (2.59 Å), while the Ru—Ru bond length (2.68 Å) of RuFe NFs is larger than those of Ru foil (2.67 Å) and RuFe NDs (2.66 Å). In addition, the coordination number (C.N.) of Ru in RuFe NFs (8.1) is much lower than that of RuFe NDs (8.9), and both of RuFe NFs and RuFe NDs are much smaller than that of Ru foil (12), which is also identified by the intensity of EXAFS spectra. In FIG. 2F, the intensity maxima of the wavelet transform (WT) of RuFe NDs and RuFe NFs is close to that of Ru foil, which further confirms the main chemical states of RuFe NDs and RuFe NFs are metallic Ru or Ru-based alloys, consisting with the above R space fitting results.

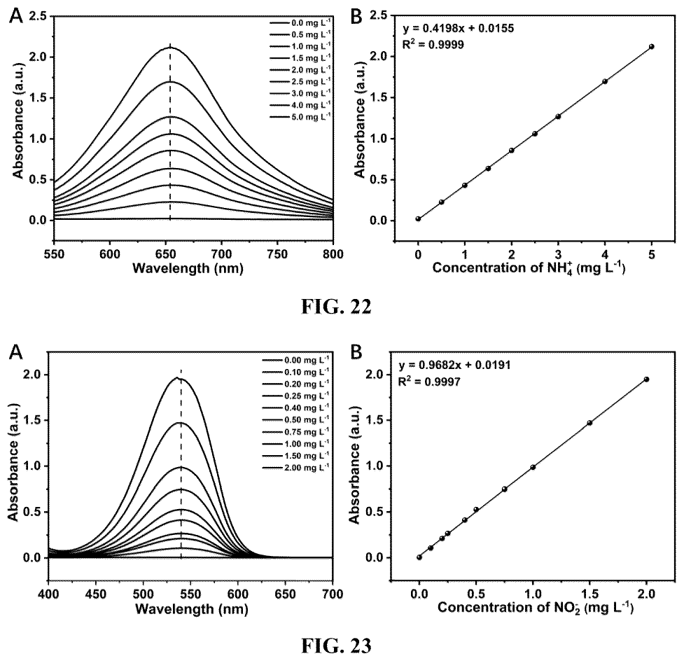

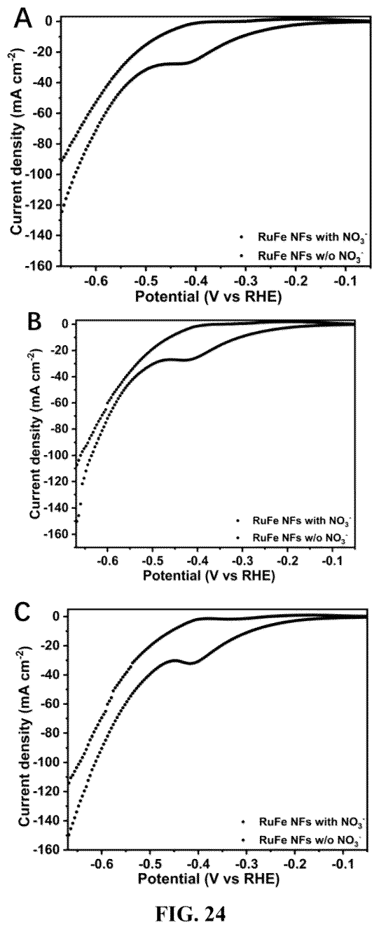

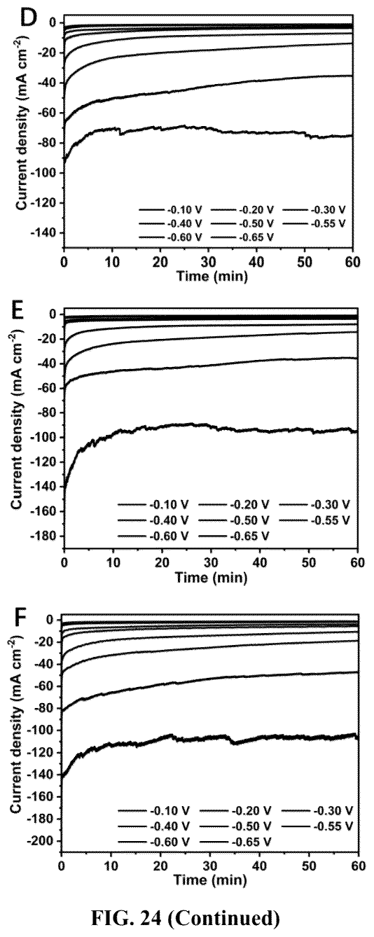

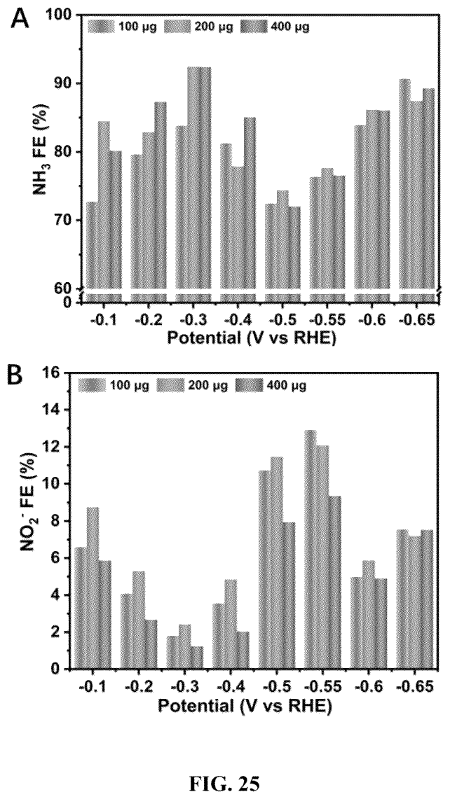

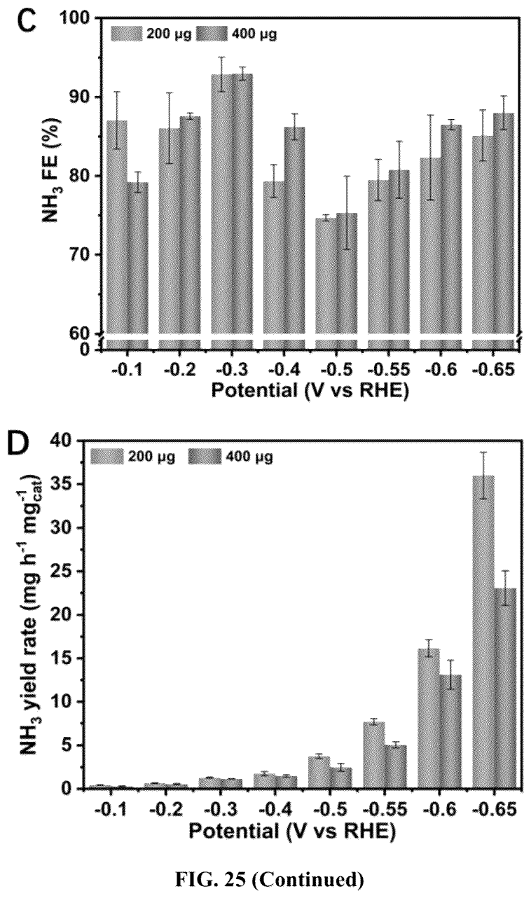

Electrochemical NO₃RR performance. The electrochemical performance test was conducted using a standard three-electrode H-type cell under ambient conditions in neutral electrolyte composed of 0.5 M Na₂SO₄ and 0.1 M NaNO₃. The obtained NH₃ and NO₂⁻ were quantitively determined by ultraviolet visible (UV-vis) spectrophotometry with the standard method (FIGS. 22 and 23). The effect of catalyst loading amount was firstly investigated with RuFe NFs (FIGS. 24 and 25). When the loading amount is 200 g, RuFe NFs show the highest NH₃ FE and lowest NO₂⁻ FE at −0.30 V (vs RHE), and a maximum NH₃ yield rate at −0.65 V (vs RHE). Therefore, the following electrochemical experiments were conducted with the catalyst loading amount of 200 g without otherwise specified. In order to unveil the origin of the superior catalytic activity of RuFe NFs toward NO₃RR, the electrocatalytic performances of Ru NSs and RuFe NDs were also measured in parallel.

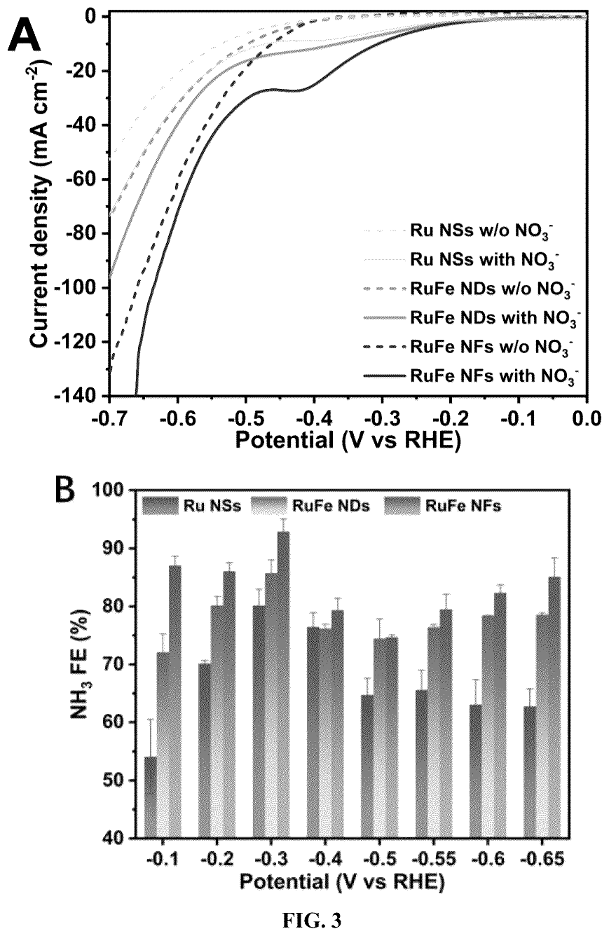

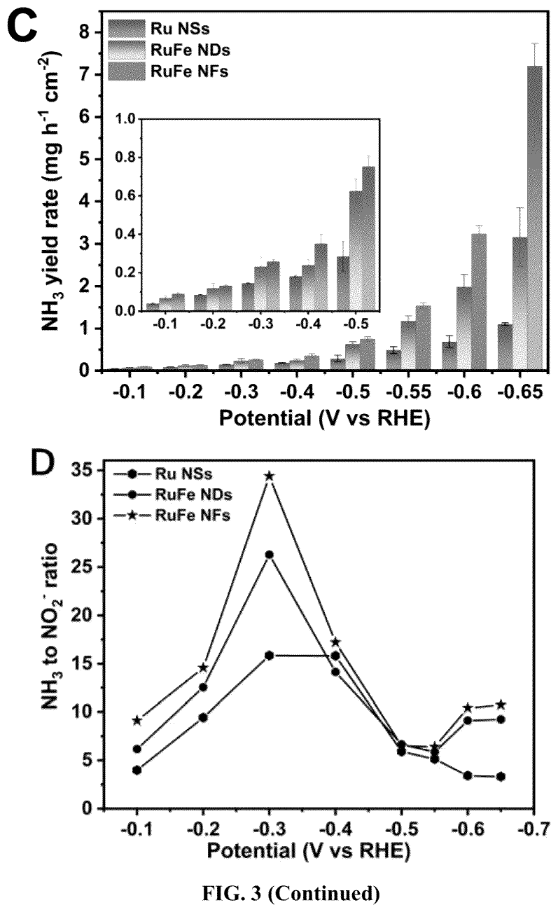

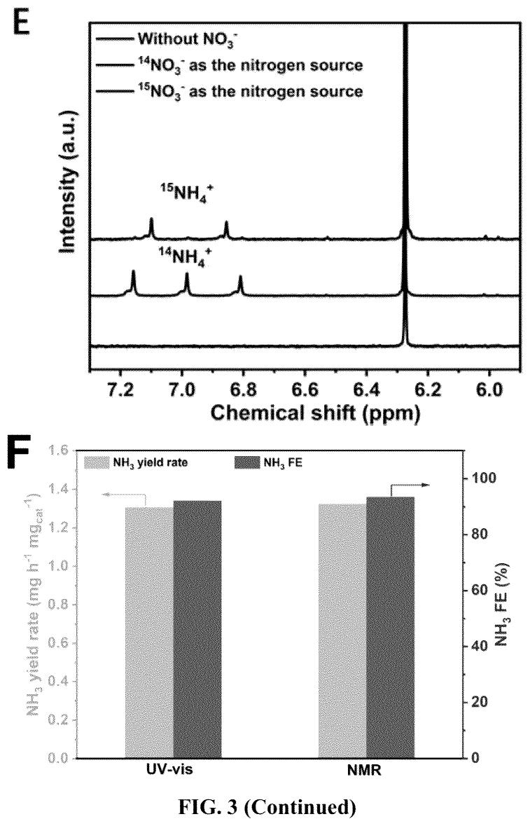

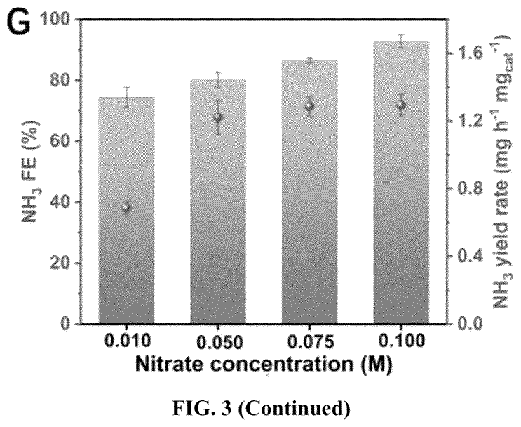

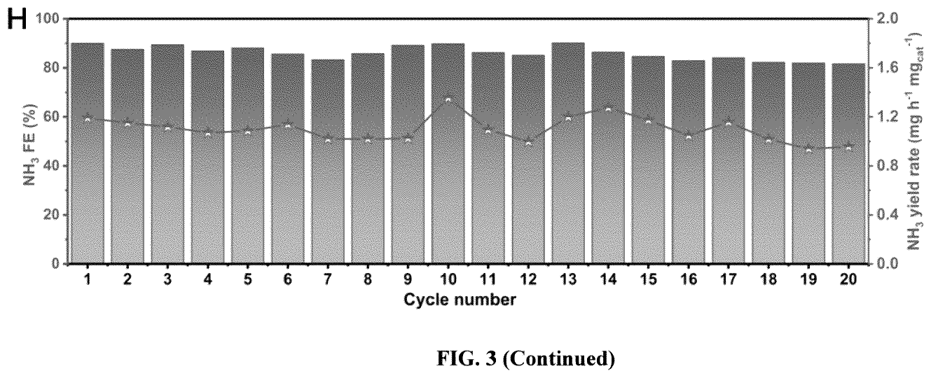

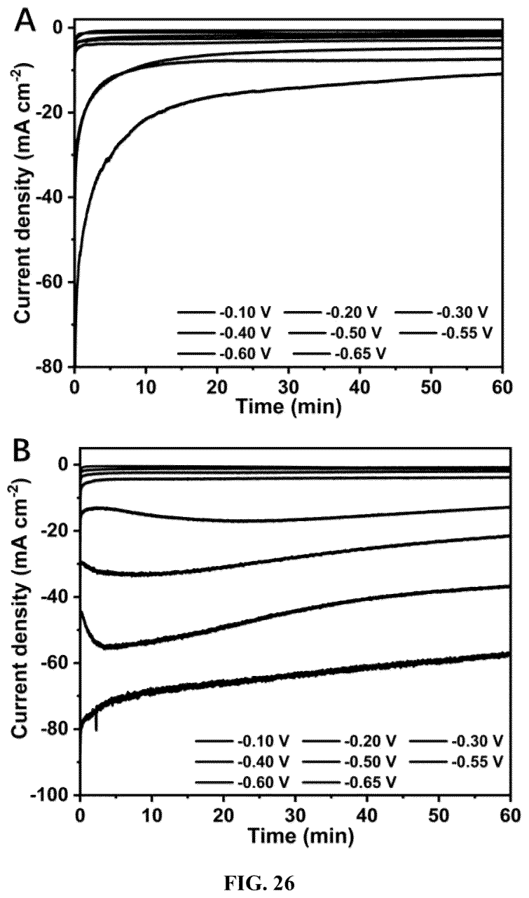

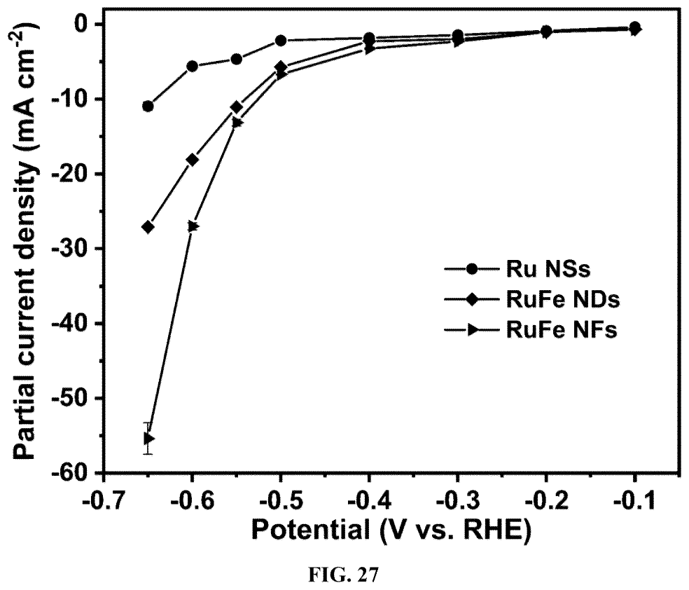

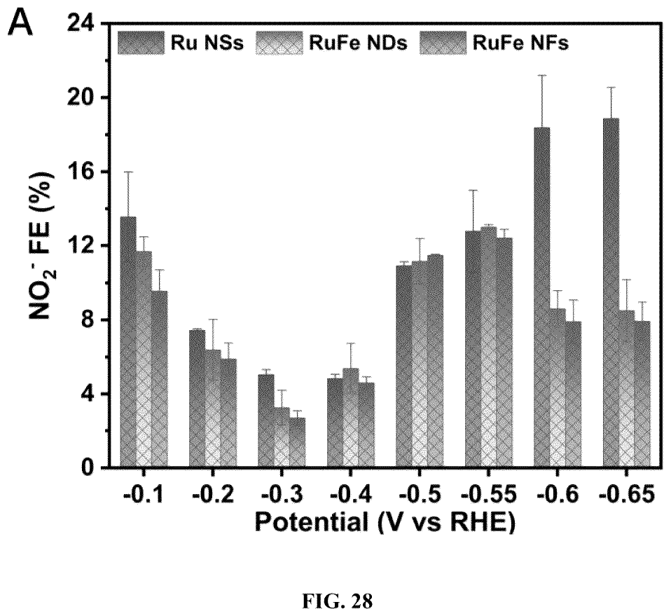

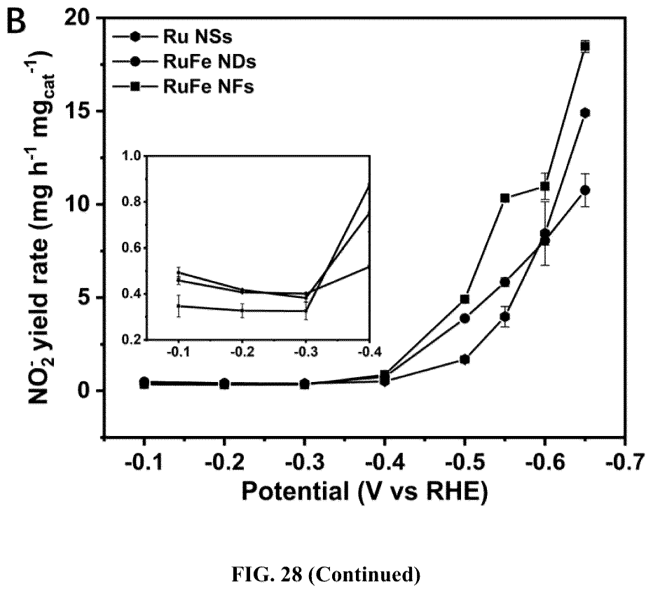

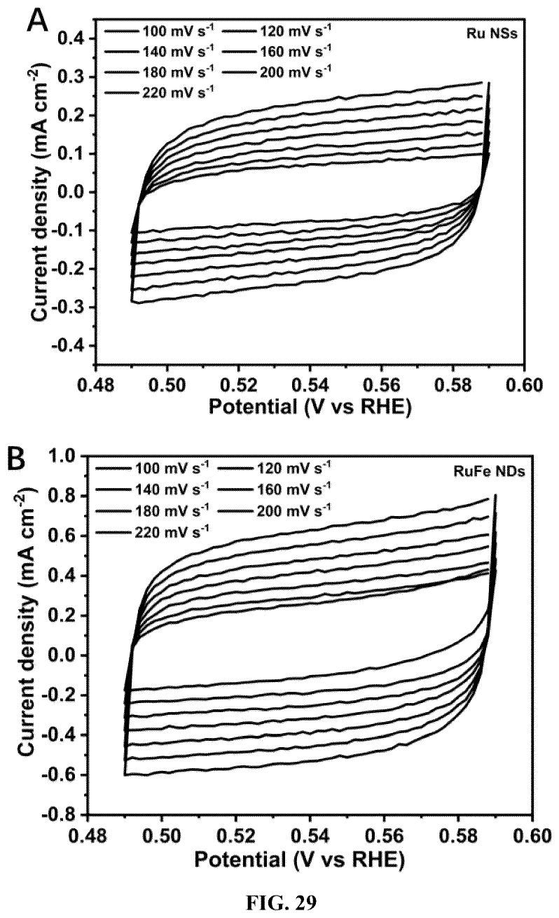

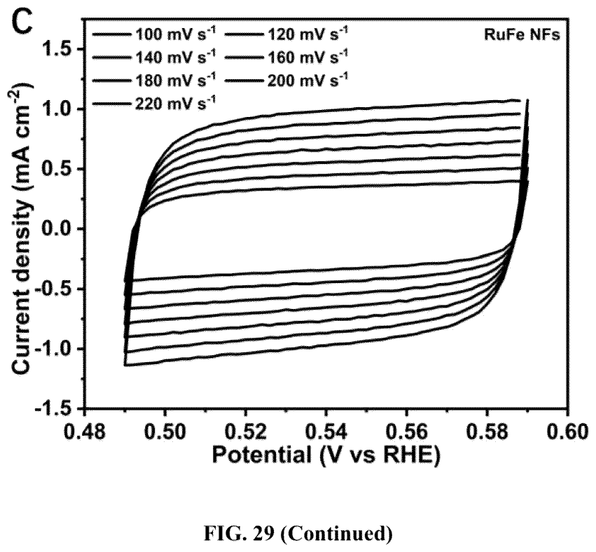

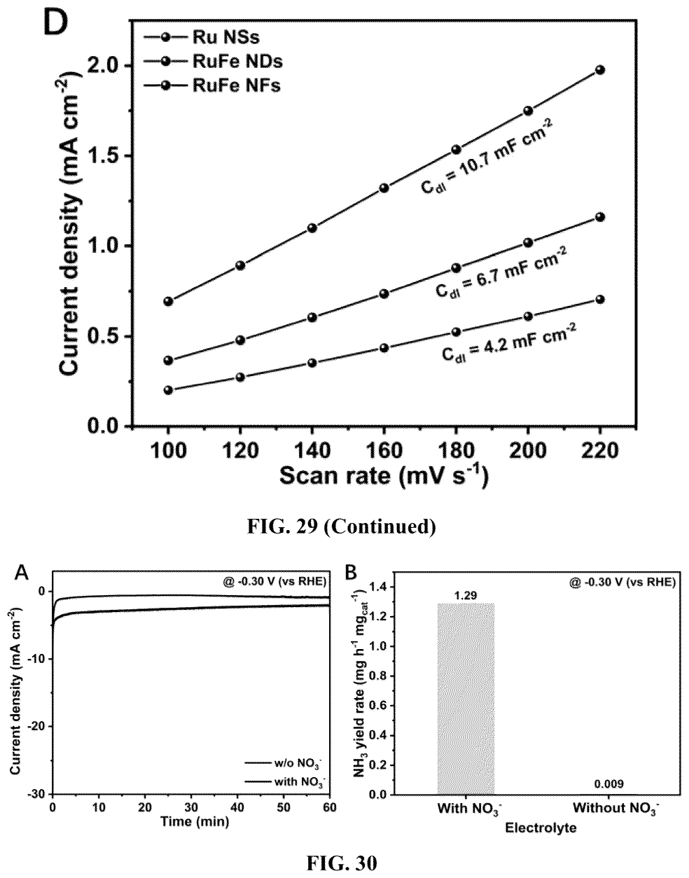

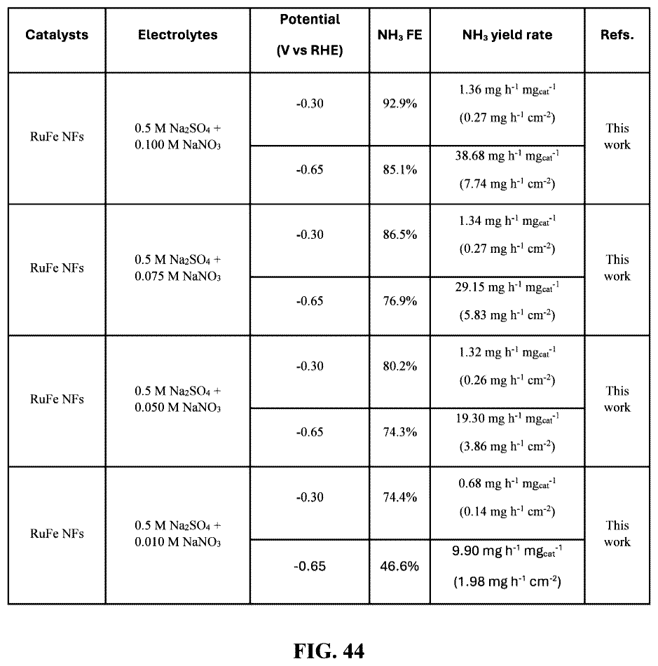

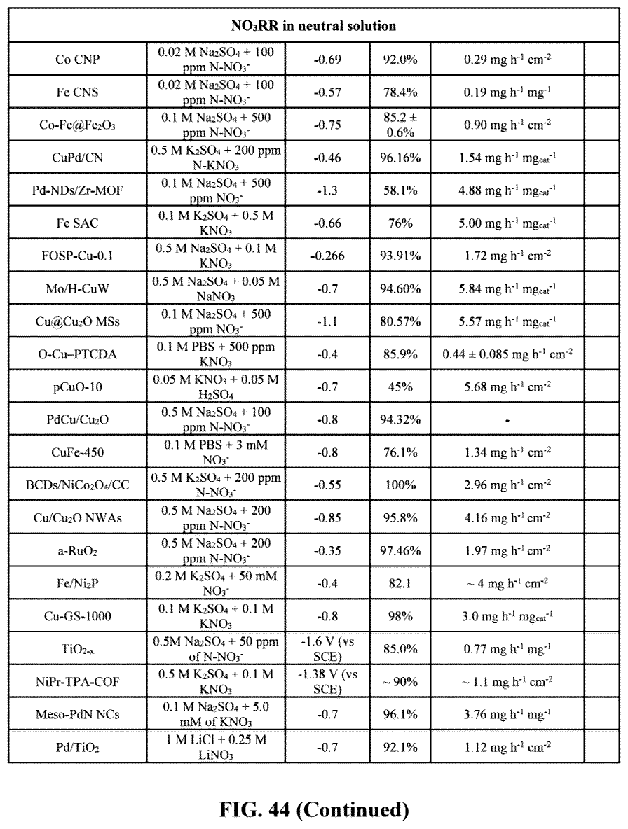

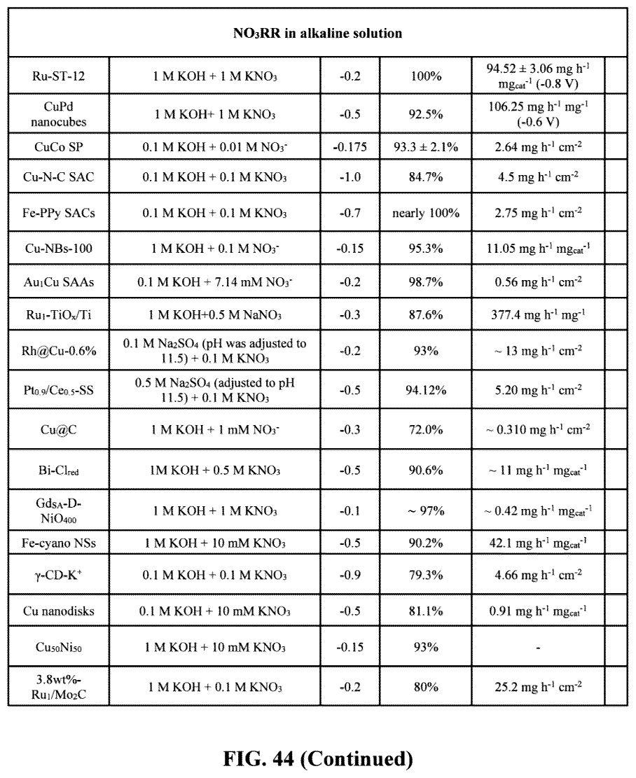

FIG. 3A shows the linear sweep voltammetry (LSV) curves of RuFe NFs, RuFe NDs and Ru NSs with and without adding NO₃⁻. In the presence of NO₃⁻, the higher current density of RuFe NFs demonstrates that RuFe NFs can achieve a better NO₃RR performance compared with RuFe NDs and Ru NSs, which is also confirmed by the potential-dependent activity results. Chronoamperometry measurements were conducted to evaluate the NO₃RR performance (FIGS. 24E and 26). In the whole potential range of −0.10 to −0.65 V (vs RHE), the NH₃ FE of RuFe NFs is higher than those of RuFe NDs and Ru NSs (FIG. 3B), with the highest NH₃ FE of 92.9% at −0.30 V (vs RHE). Remarkably, RuFe NFs demonstrate a much higher NH₃ yield rate than those of Ru NSs and RuFe NDs at all the tested potentials, and achieve the highest value of 38.68 mg h⁻¹ mg_{cat}⁻¹ (64.47 mg h⁻¹ mg_{Ru}⁻¹) at −0.65 V (vs RHE), which is approximately 6.8 and 2.1 times those of Ru NSs and RuFe NDs, respectively (FIG. 3C). Benefiting from the high FE of NH₃, a large partial current density of 55.4 mA cm-² was achieved for NH₃ production on RuFe NFs (FIG. 27). Along with the formation of NH₃, NO₂ is a typical by-product during the NO₃RR. As shown in FIG. 28, RuFe NFs show the lowest NO₂ FE and yield rate of only 2.7% and 0.30 mg h⁻¹ mg_{cat}⁻¹ at −0.30 V (vs RHE), respectively. Notably, RuFe NFs exhibit a much higher NH₃-to-NO₂⁻ ratio than both Ru NSs and RuFe NDs at almost all the measured potentials, reaching a maximum ratio of 34.4 at −0.30 V (vs RHE) (FIG. 3D). In addition, the electrochemically active surface areas (ECSAs) of Ru NSs, RuFe NDs and RuFe NFs were measured to be 105.0, 167.5 and 267.5 cm², respectively, by using the electrochemical double layer capacitance (C_{dl}) method (FIG. 29). The larger of the ECSA is, the more active sites exposed on the surface of catalysts, which is beneficial for the superior catalytic activity. It should be mentioned that the RuFe NFs exhibit superior NH₃ FE and yield rate with low overpotentials, surpassing most of the reported metal-based heterogeneous catalysts (FIG. 44). The superior NO₃RR performance of RuFe NFs could arise from the following aspects. First, the low-coordinated Ru sites in RuFe NFs would enhance the adsorption and activation of reactants/intermediates. Second, the electronic structure of Ru is modulated with the introduction of Fe (FIG. 2A), which may contribute to the optimization of *H coverage on the catalyst surface, promoting NH₃ synthesis and simultaneously suppressing the competing HER. Third, RuFe NFs consist of ultrathin 2D nanosheets, where extensive under-coordinated atoms are exposed, providing abundant active sites for NO₃RR (FIG. 29). Nevertheless, great efforts are still needed to further improve the NO₃RR performance of metal nanostructures compared with highly-dispersed molecular catalysts. It should be noted that molecular catalysts with tunable structures and well-defined active centers can enable rapid electron and proton transfer in NO₃RR toward efficient NH₃ production.

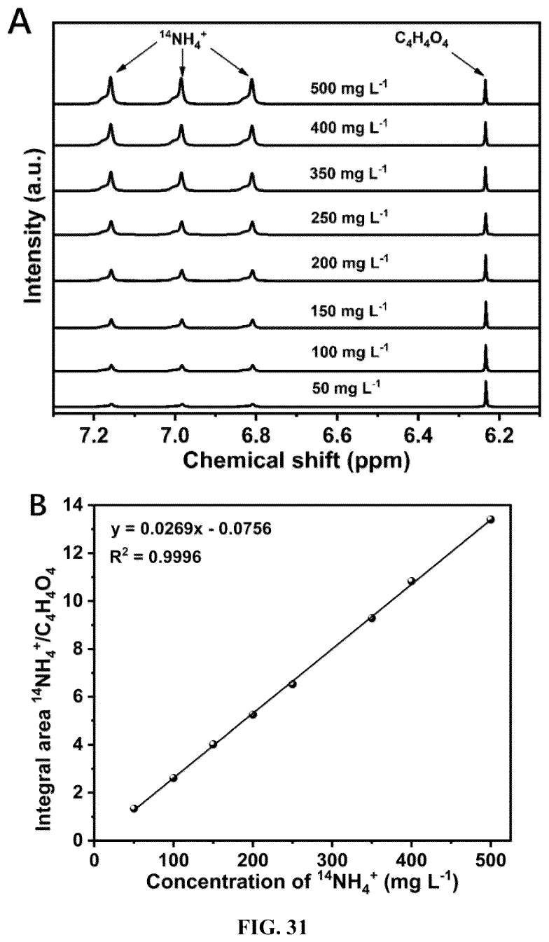

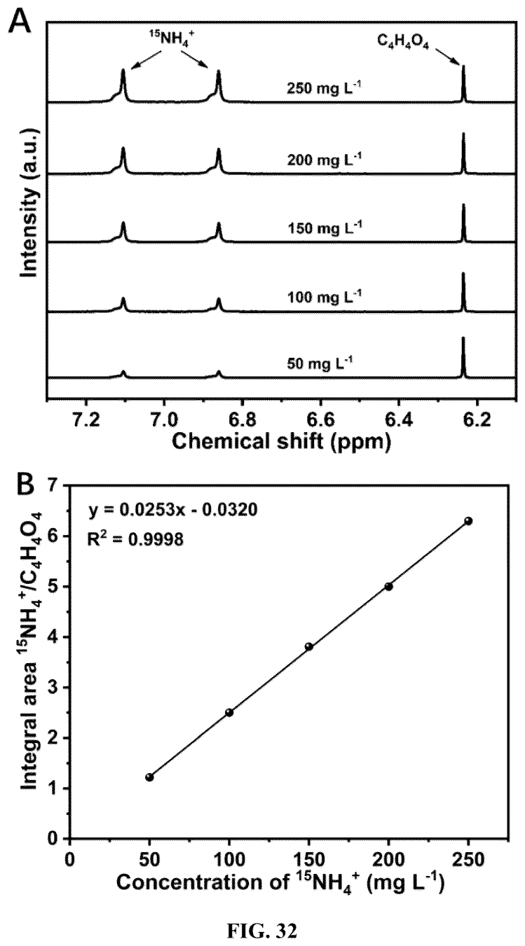

To confirm the NO₃RR performance and rule out the interference of the electrocatalysts, the testing equipment and/or other environmental factors, control experiments were conducted in 0.5 M Na₂SO₄ in the absence of NaNO₃. In this case, the current density is much lower than that with NaNO₃ and the yield rate of NH₃ is neglectable (FIG. 30). Isotope labeling experiments were further performed to validate if the NH₃ was originated from the feeding nitrate source. As shown in FIG. 3E, triple peaks and double peaks attributed to ¹⁴NH₄⁺ and ¹⁵NH₄⁺ can be observed when the nitrogen sources are Na¹⁴NO₃ and Na¹⁵NO₃, respectively. This result confirms that the NH₃ was synthesized by the feeding nitrogen source instead of the other sources/contaminants. Moreover, the FE and yield rate of obtained NH₃ were also quantified by both UV-vis and nuclear magnetic resonance (NMR) methods to verify their accuracy (FIGS. 31 and 32). As shown in FIG. 3F, after electrolysis at −0.30 V (vs RHE) for 1 h, the NH₃ FE and yield rate calculated by the UV-vis method are in good agreement with those via the NMR approach, suggesting the high accuracy and also the reliability of the experimental results.

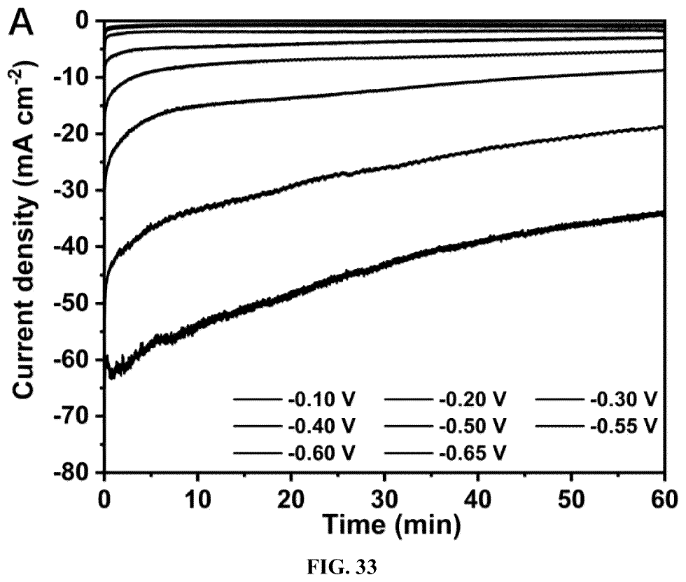

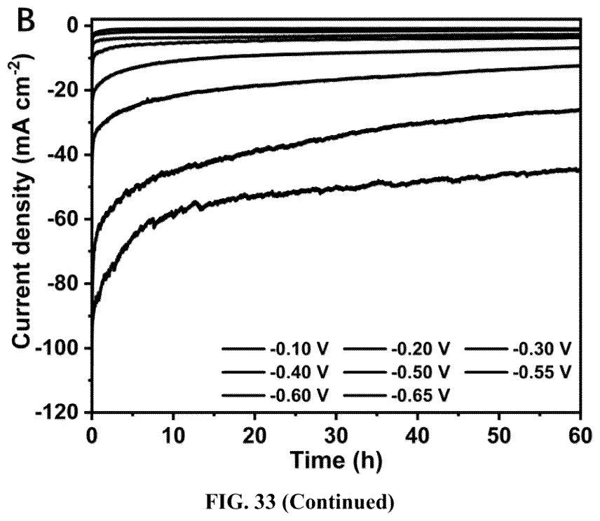

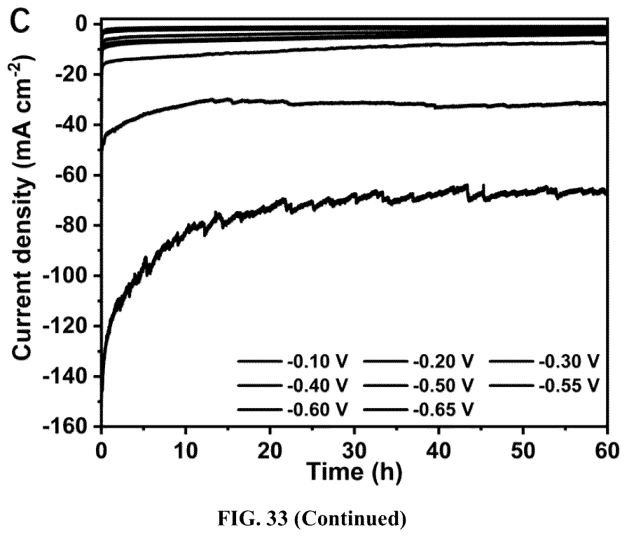

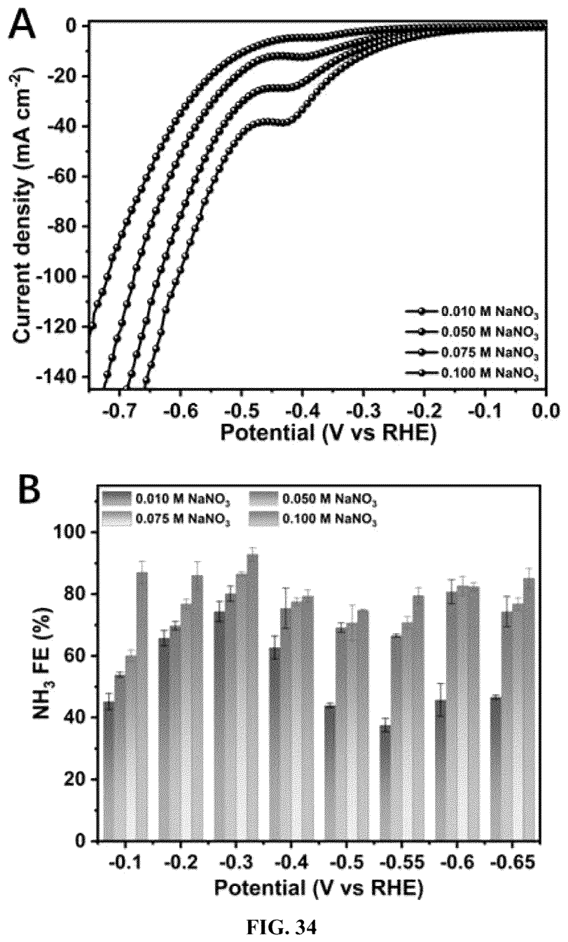

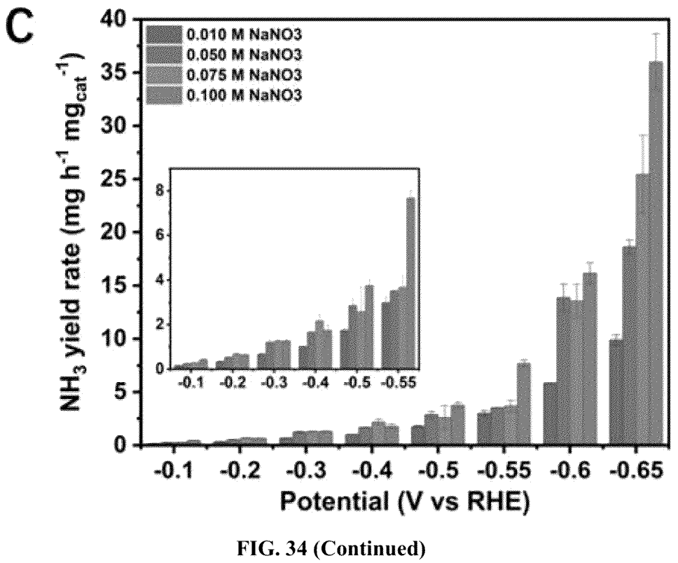

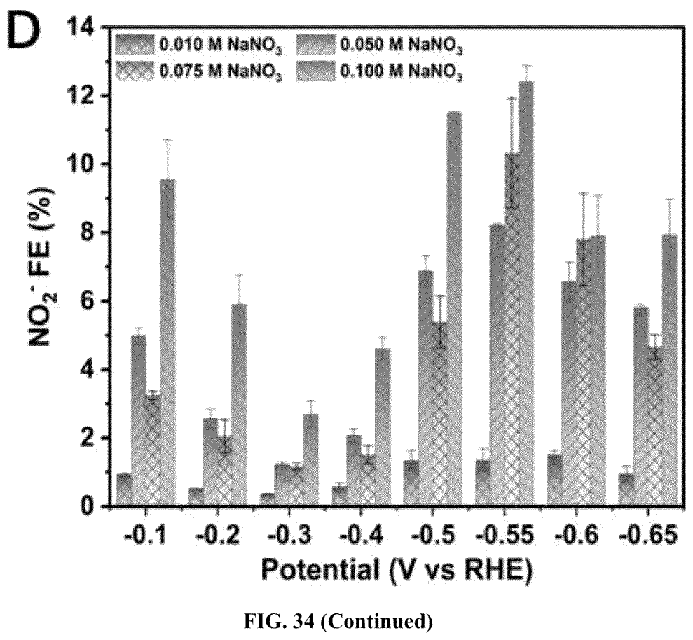

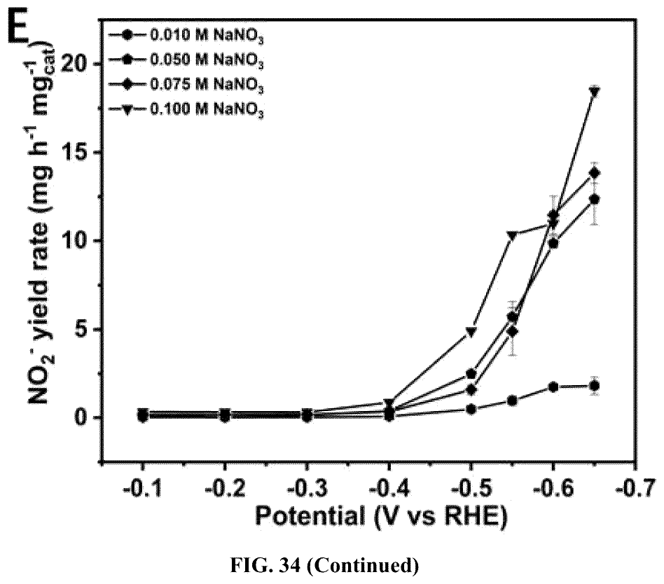

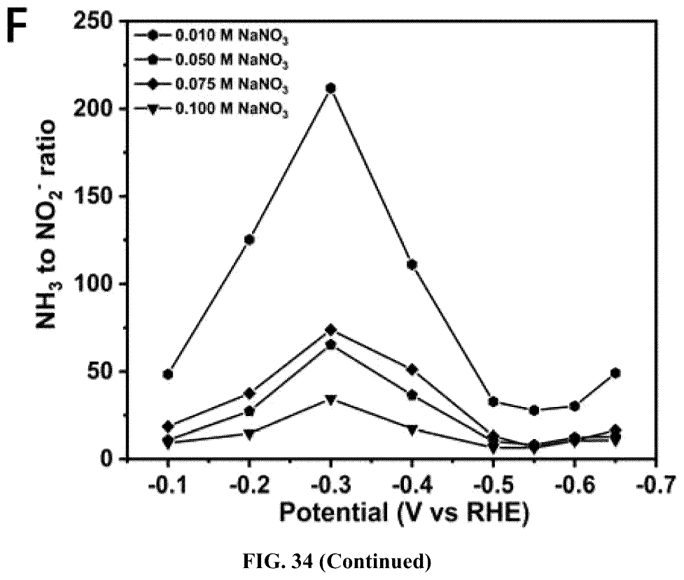

The influence of nitrate concentration on the NO₃RR performance of RuFe NFs was also investigated (FIGS. 33 and 34). It is known that the competing HER is more favorable with reducing the nitrate concentration during NO₃RR. By decreasing the nitrate concentration from 0.100 M to 0.010 M, RuFe NFs can still achieve a maximum NH₃ FE of 74.4% at −0.30 V (vs RHE), together with NH₃ yield rate of 9.90 mg h⁻¹ mg_{cat}⁻¹ at −0.65 V (vs RHE) (FIG. 3G and FIGS. 34 B and C), indicating good catalytic activity toward NO₃RR even at relatively low nitrate concentration. For NO₂⁻, RuFe NFs show lower FE and yield rate at 0.010 M NaNO₃ compared to those at 0.100 M NaNO₃ (FIGS. 34 D and E). When the initial nitrate concentration is 0.010 M, a large NH₃-to-NO₂⁻ ratio of 211.8 can be realized at −0.30 V (vs RHE), which is much higher than those at 0.050 M (65.4), 0.075 M (73.8) and 0.100 M (34.4) (FIG. 34 F). The above results further indicate the superior catalytic activity of RuFe NFs for NO₃RR even at low nitrate concentration.

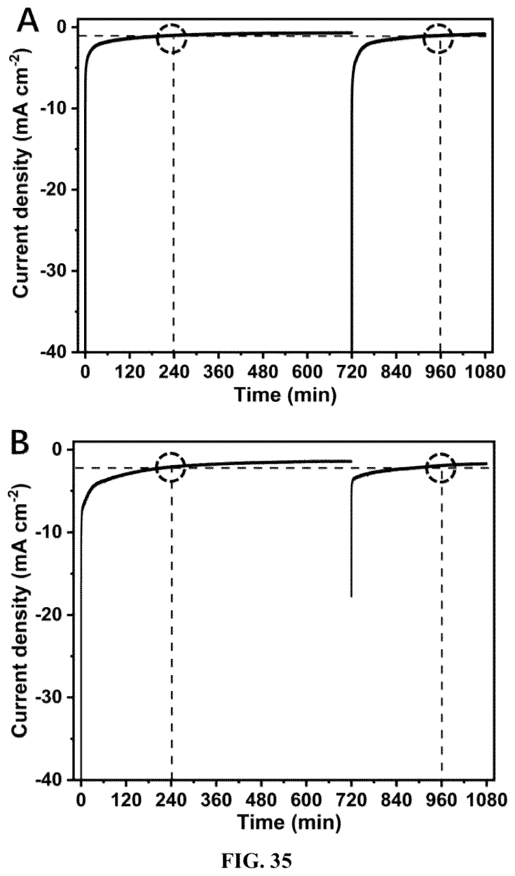

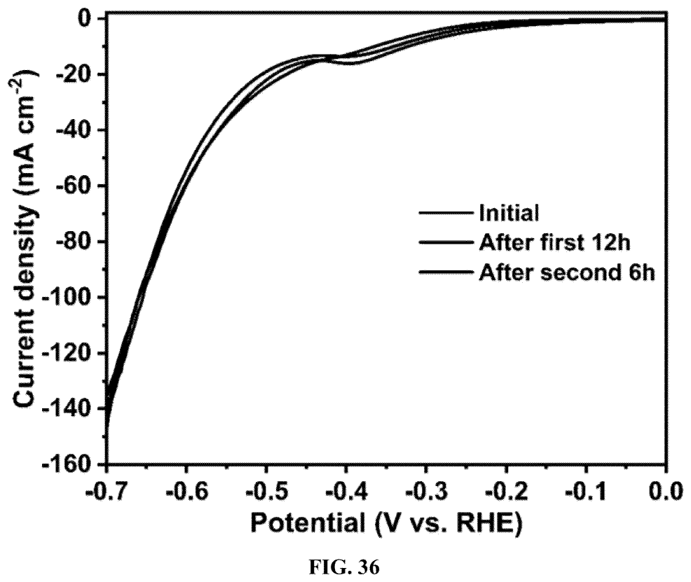

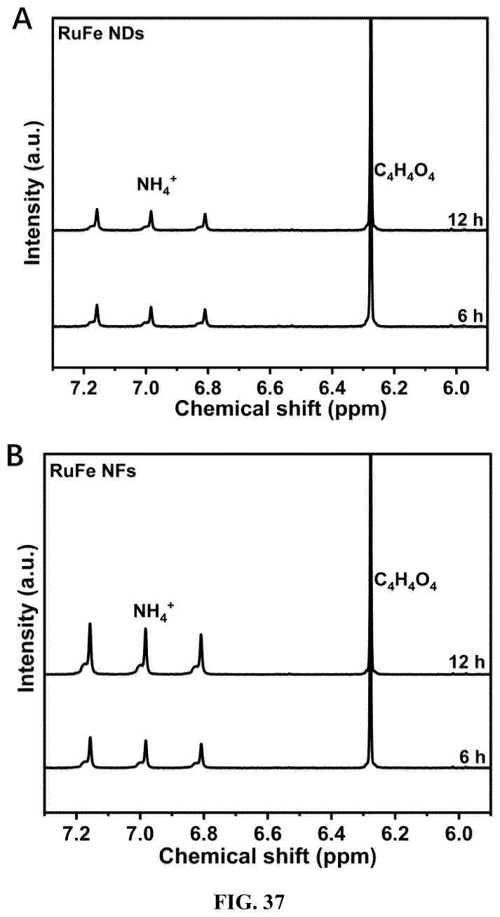

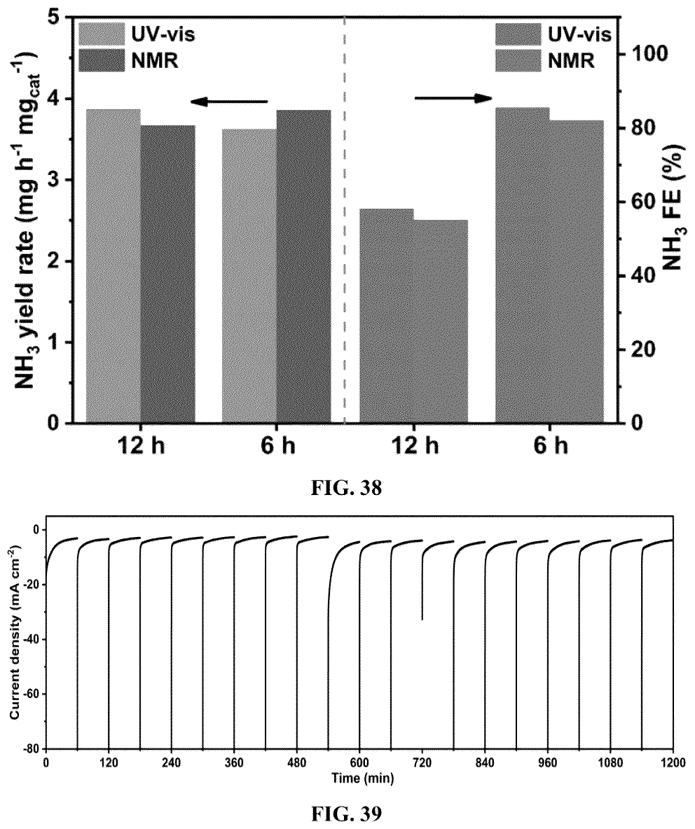

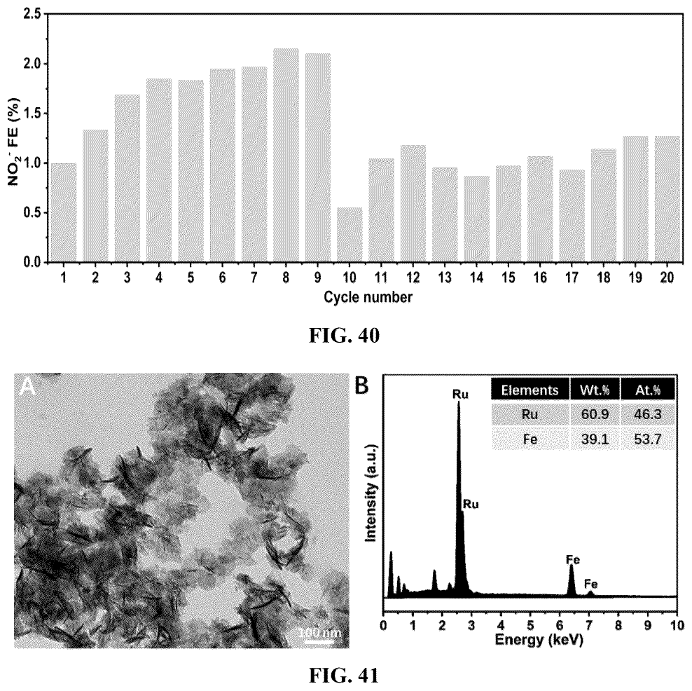

The catalytic durability of RuFe NFs was evaluated by using long-term chronoamperometry test. The chronoamperometry test of RuFe NFs and RuFe NDs was performed under −0.30 V (vs RHE) for 12 h. After refreshing the electrolyte, nitrate electrolysis for another 6 h was conducted. During the first 12 h electrolysis process, the current density was decreased with prolonged reaction time, but it increased to the original level again after refreshing the electrolyte (FIG. 35). The LSV curves of RuFe NFs at initial state, after the first 12 h electrolysis and after the second 6 h electrolysis are similar with each other, indicating the excellent catalytic stability (FIG. 36). The decrease of current density during the long-time reaction process could be attributed to the gradually reduced NO₃⁻ concentration. The FE and yield rate of NH₃ during this process were measured and quantified by both NMR and UV-vis methods (FIGS. 37 and 38). In addition, the durability test was also conducted by the consecutive recycling electrolysis at −0.30 V (vs RHE). During the 20 consecutive cycles, the chronoamperometry curve of each cycle kept almost the same tendency (FIG. 39). The NH₃ FE and yield rate only demonstrated a slight decrease, indicating the excellent stability for NO₃RR (FIG. 3H). Meanwhile, the FE of NO₂ remained at a very low level of <2.5% (FIG. 40). After stability test, the catalysts were characterized by TEM and EDS, which exhibit that the size, morphology and composition are well preserved (FIG. 41). These results reveal the outstanding structural and chemical stability of RuFe NFs during the NO₃RR test.

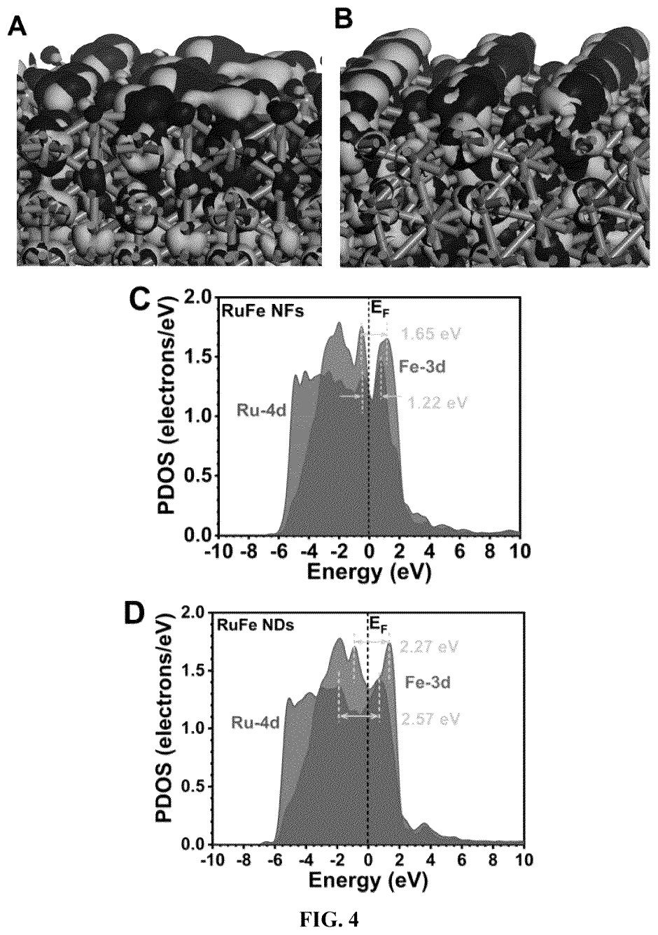

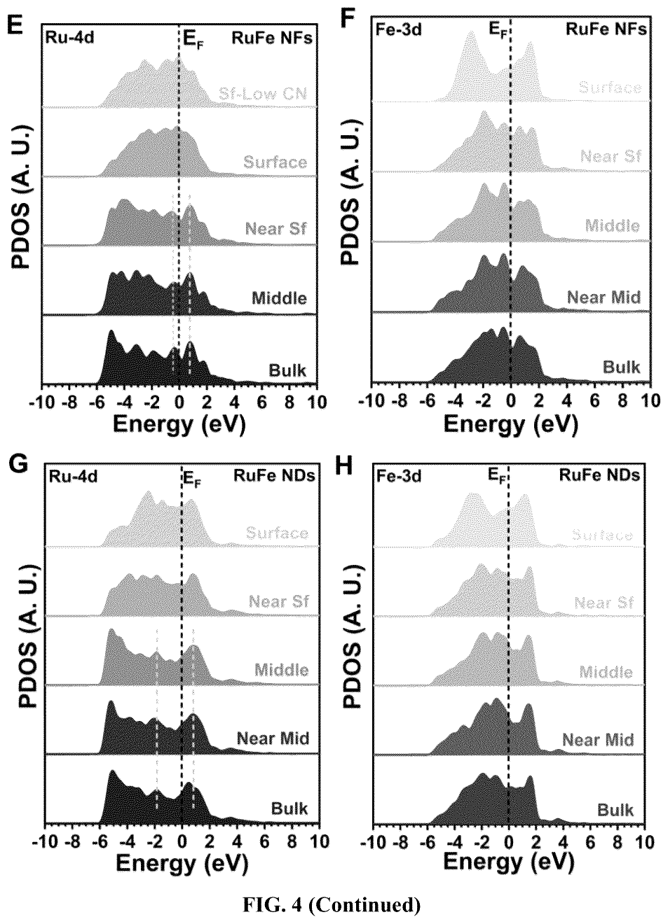

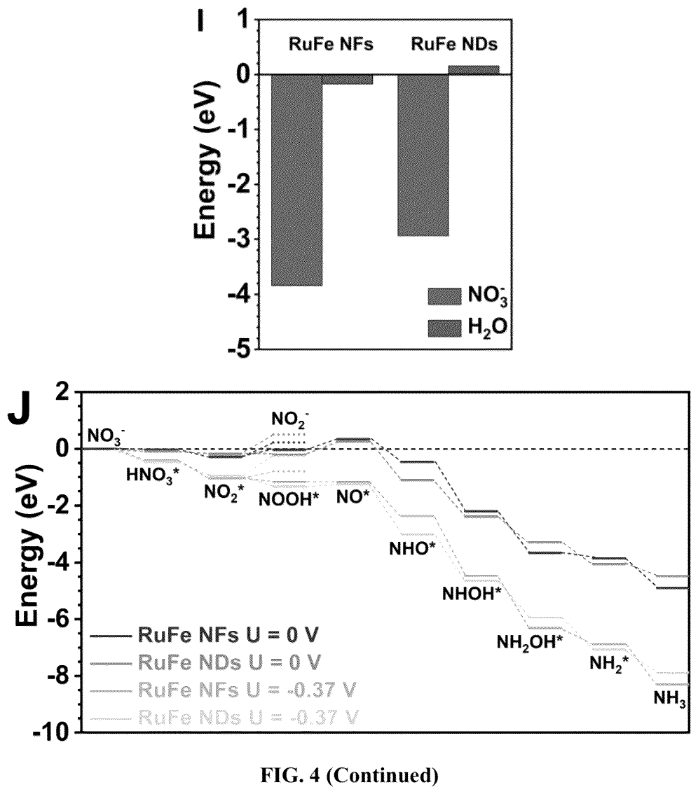

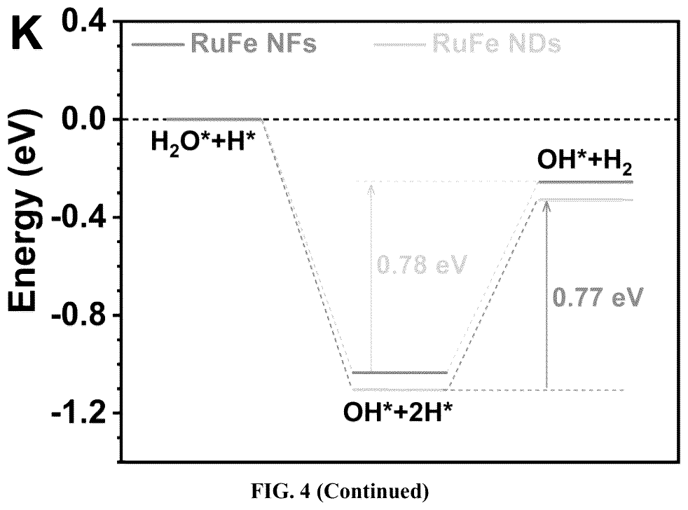

Theoretical calculations. In order to better understand the superior NO₃RR performance of RuFe NFs, we have further introduced DFT calculations to compare the electronic structures and reaction energy between RuFe NFs and RuFe NDs. The surface electronic distributions near the Fermi level (E_{F}) are demonstrated, where the electroactive bonding orbitals are mainly located on the low-coordinated Ru sites on the surface of RuFe NFs, indicating their high electroactivity (FIG. 4A). It is noted that Ru sites also display strong orbital coupling to guarantee efficient electron transfer. For the RuFe NDs, the electronic distributions are more regulated on the surface, where both bonding and anti-bonding orbitals are concentrated on Ru sites (FIG. 4B). From the electronic distributions, the surface Ru sites have been identified as the main active sites for NO₃RR, where different electronic structures lead to varied performances. To have an in-depth understanding of the electronic modulations, the projected partial density of states (PDOSs) was carried out to explore the detailed contributions. In RuFe NFs, both Ru-4d and Fe-3d orbitals have shown e_{g}-t_{2g} splitting near the E_{F} with a barrier of 1.22 eV and 1.65 eV, respectively (FIG. 4C). The relatively small splitting barriers have offered a more beneficial environment for electron transfer during electrocatalysis. Meanwhile, the good orbital overlapping between Ru-4d and Fe-3d orbitals indicates that Fe sites play a significant role in maintaining the stable valence states of Ru sites. In comparison, we notice that the e_{g}-t_{2g} splitting barriers in RuFe NDs have been evidently enlarged to 2.57 eV and 2.27 eV for Ru-4d and Fe-3d orbitals, respectively (FIG. 4D). This leads to increased energy barriers for electron transfer from the electrocatalysts to the intermediates, which lowers the overall NO₃RR performances. In addition, the d-band center of RuFe NFs is E_{V}−1.01 eV (E_{V} denotes 0 eV), which is closer to E_{F} than that of RuFe NDs (E_{V}−1.12 eV), supporting the improved electroactivity of RuFe NFs. To understand the electronic evolutions of Ru and Fe sites, the site-dependent PDOSs are displayed. In RuFe NFs, Ru-4d orbitals remain similar e_{g}-t_{2g} splitting from the bulk to the near-surface sites (FIG. 4E). Notably, the e_{g}-t_{2g} splitting is absent for surface Ru sites. In particular, compared to the normal surface sites, the low-coordinated Ru sites deliver even higher electron density to offer fast electron transfer pathways. Meanwhile, for the Fe sites, the electronic structures of Fe-3d orbitals are highly similar from the bulk to the near-surface sites (FIG. 4F). However, the surface Fe sites exhibited a converse trend, where the e_{g}-t_{2g} splitting has evidently increased on the surface. This leads to the complementary electronic structures, where Ru-4d orbitals are well protected by the Fe-3d orbitals, supplying robust active sites with stable valence states during NO₃RR. For the RuFe NDs, Ru-4d orbitals also deliver a similar trend from the bulk to the surface (FIG. 4G). Compared to RuFe NFs, the e_{g}-t_{2g} splitting is alleviated but still exists, which demonstrates a relatively lower electroactivity of RuFe NDs. In the meantime, the electronic evolutions of Fe-3d orbitals indicate that Fe-3d orbitals are not strongly affected, leading to weaker orbital complementation than that in RuFe NFs (FIG. 4H). The decreased NO₃RR performance of RuFe NDs is attributed to the lower electroactivity and less stable electronic structures of active sites.

Then we discuss the electrocatalytic performance from the energy perspective. The adsorption energies of reactants (i.e., NO₃⁻ and H₂O) are critical to the NO₃RR performance (FIG. 4I). Although both RuFe NFs and RuFe NDs prefer the adsorption of NO₃⁻, RuFe NFs show higher preferences due to the stronger adsorption. On the other side, compared to the spontaneous adsorption of H₂O on RuFe NFs, the energy cost (0.16 eV) of H₂O adsorption on RuFe NDs also lowers the reduction process. To reveal the reaction process, the overall energy changes are compared based on different applied potentials (U, FIG. 4J). Under U=0 V, both RuFe NFs and RuFe NDs have displayed continuous energy barriers of the NO₂* reduction to NO*, where the conversion of NOOH* to NO* displays the highest energy barrier as the potential-determining step (PDS). The energy barrier of PDS is 0.37 eV and 0.47 eV for RuFe NFs and RuFe NDs, respectively. According to the PDS and electron transfer number, all the reaction steps become spontaneous on RuFe NFs after applying a potential of −0.37 V, supporting the high NO₃RR performance. This is very close to the experimental characterization, where the highest NH₃ FE is achieved at an applied potential of −0.30 V (FIG. 3B). In contrast, under the applied potential of −0.37 V, an energy barrier of 0.10 eV still exists on RuFe NDs for the PDS, which is consistent with the lower NH₃ FE of RuFe NDs. Moreover, the overall reaction energy of RuFe NFs is more exothermic than that of RuFe NDs, indicating the stronger reaction trend of NO₃RR on RuFe NFs. For the desorption of NO₂⁻, there are evident energy barriers for both RuFe NFs and RuFe NDs, which are 0.51 and 0.68 eV, respectively. These large energy barriers strongly hinder the formation of NO₂⁻ with low FE and yield rate, consistent well with experimental results (FIGS. 28 and 34 E). As the main competitive reaction during NO₃RR, we also investigated the HER trends (FIG. 4K). We notice that both RuFe NFs and RuFe NDs exhibit a spontaneous dissociation of H₂O, while the formation of H₂ shows a large energy barrier. In contrast to the PDS of NO₃RR, the energy barriers of HER on RuFe NFs (0.78 eV) and RuFe NDs (0.77 eV) are much larger, which strongly suppresses the generation of H₂. This also well explains the favored NH₃ generation of experimental observations at different potentials from another aspect (FIG. 3B).

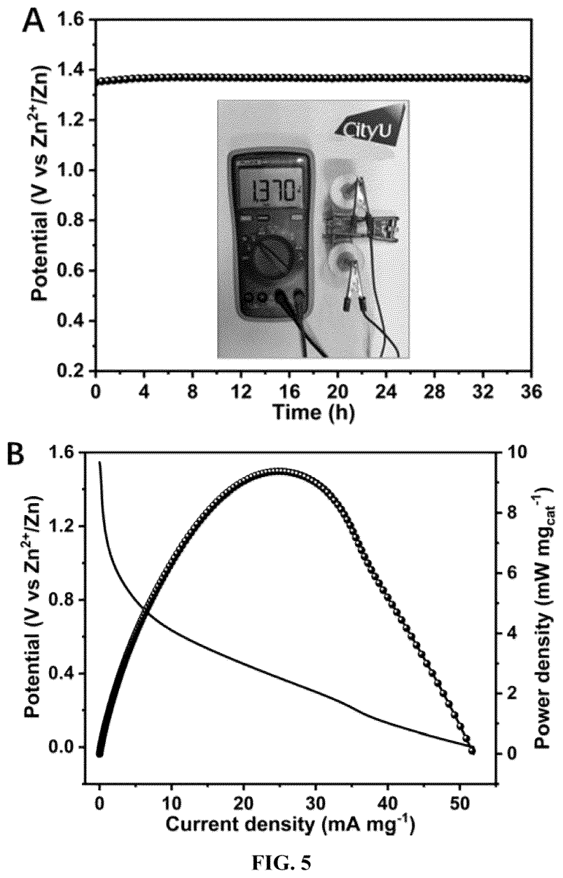

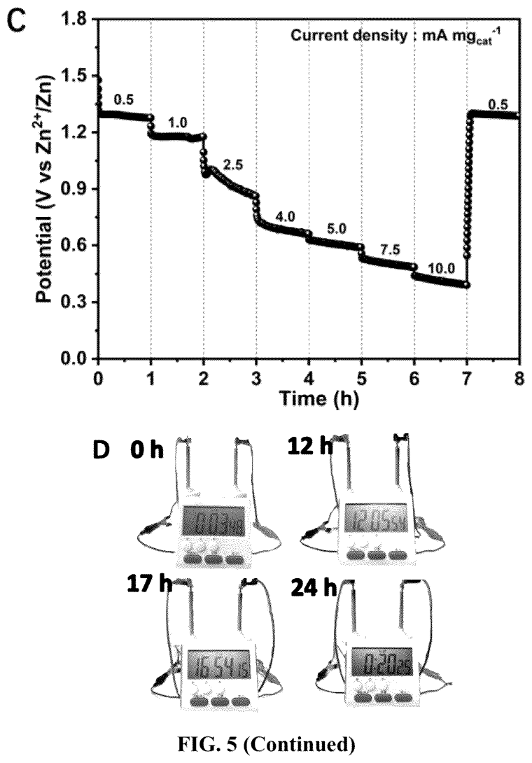

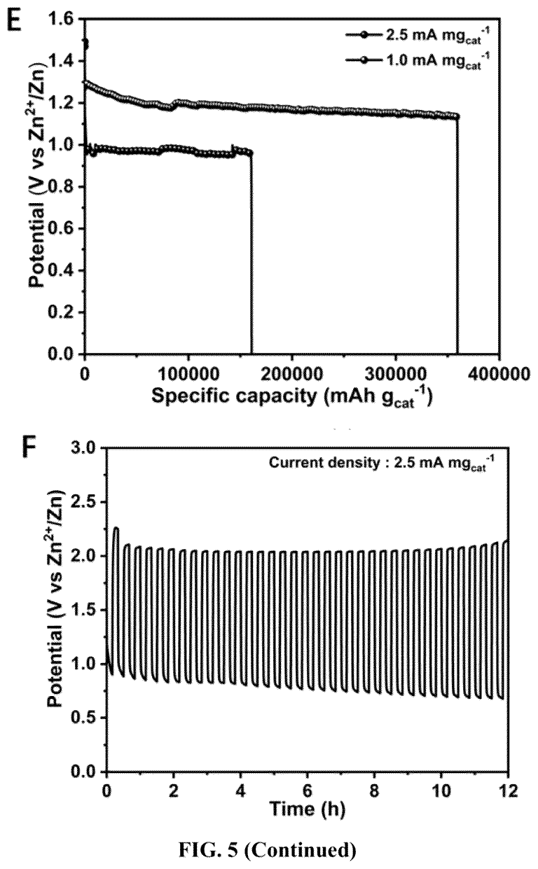

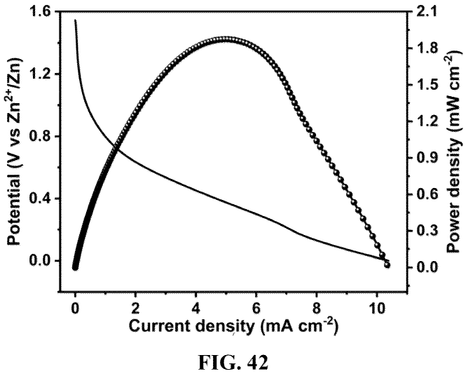

Demonstration of rechargeable Zn—NO₃⁻ battery. Considering the high energy density of NH₃ (4.32 kW h L-¹), it is also regarded as a potential energy carrier in both chemical engineering and energy storage systems. Noteworthily, the equilibrium potential of NO₃RR is 0.69 V (vs RHE), much higher than 0.40 V (vs RHE) of oxygen reduction reaction (ORR) in zinc-air batteries, which means large energy density can be obtained with NO₃RR as the cathode reaction in an electrochemical device. In light of this, it is also quite compelling to assemble Zn—NO₃-battery system to utilize the electrons originating from the NO₃RR process, which can not only exhibit a large theoretical energy density of 1,051 W h Kg⁻¹, but also provide a feasible strategy for ammonia production and sewage disposal in the future. Based on the experimental results, RuFe NFs demonstrate excellent FE and outstanding yield rate toward NH₃ synthesis at a relatively low overpotential. As a proof-of-concept application, a Zn—NO₃⁻ battery was constructed using RuFe NFs as the catalyst cathode. As shown in FIG. 5A, the assembled battery delivers a high open circuit potential (OCP) of 1.370 V (vs Zn²⁺/Zn), which remains very stable within the rest period of 36 h. FIG. 5B shows the discharging polarization curves of Zn—NO₃⁻ batteries with RuFe NFs. It can be seen that the output current of Zn—NO₃⁻ battery gradually increases when the potential proceeds negatively. And a maximum power density of 9.5 mW mg_{cat}⁻¹(or 1.9 mW cm⁻²) is realized at 0.375 V (vs Zn²⁺/Zn) (FIG. 5B and FIG. 42). Moreover, the as-fabricated Zn—NO₃⁻ battery displays an excellent rate performance, which can work normally within a broad current density range of 0.5 to 10 mA mg_{cat}⁻¹ (FIG. 5C). To demonstrate the application in real scenarios, the RuFe NFs based Zn—NO₃⁻ battery was employed to power a commercial digital clock with light-emitting diode (LED) screen for above 24 h (FIG. 5D). In addition, the practical energy densities of the Zn—NO₃⁻ battery were further quantified via deep discharging at the current densities of 1.0 and 2.5 mA mg_{cat}⁻¹, which delivers an outstanding specific capacity of 359,233 and 160,419 mAh g_{cat}⁻¹, respectively (FIG. 5E). It is also noteworthy that the RuFe NFs based Zn—NO₃⁻ batteries can achieve the rechargeable process, during which Zn deposition and oxygen evolution reaction (OER) will occur at the anode and cathode, respectively. FIG. 5F shows the typical discharge-charge profiles of Zn—NO₃⁻ batteries under the current density of 2.5 mA mg_{cat}⁻¹. Significantly, the assembled batteries can steadily run for 12 h (or 36 cycles), with only a slight decay of the discharge and charge potentials. These results reveal the great potential application of RuFe NFs in advanced energy conversion and storage.

An ultrathin nanosheet-assembled RuFe alloy NFs with low-coordinated Ru sites was synthesized by a simple one-pot solvothermal method for highly efficient NO₃RR in neutral electrolyte. It was observed that RuFe NFs demonstrate much superior electrocatalytic performance over Ru NSs and RuFe NDs in NO₃RR. Remarkably, compared with Ru NSs (5.66 mg h⁻¹ mg_{cat}⁻¹) and RuFe NDs (19.26 mg h⁻¹ mg_{cat}⁻¹), RuFe NFs delivered outstanding NH₃ yield rate of 38.68 mg h⁻¹ mg_{cat}⁻¹ (64.47 mg h⁻¹ mg_{Ru}⁻¹) at −0.65 V (vs RHE), surpassing most of the reported heterogeneous NO₃RR electrocatalysts, and also a stable NH₃ electrosynthesis for 20 cycles without obvious decrease in FE and yield rate. Alternatively, RuFe NFs can still achieve efficient NO₃RR even with relatively low nitrate concentration. DFT calculations have investigated the electronic modulations in RuFe NFs induced by the lower C.N. of Ru active sites, which supplies the improved electroactivity and stronger reaction trends than that of RuFe NDs. In particular, the surface Ru-4d and Fe-3d orbitals of RuFe NFs constructed a highly stable electronic structure due to the complementary orbitals to reach efficient electron transfer and robust valence states. The reaction energy changes proved the lower energy barriers of PDS on RuFe NFs, which also suppresses the competitive HER during the NO₃RR. Furthermore, the successful demonstration of high-specific capacity Zn—NO₃⁻ batteries with RuFe NFs as catalyst cathode suggested their important potential applications in advanced energy devices. This work offers a promising and feasible strategy to enhance the electrochemical NO₃RR performance via atomic coordination environment engineering of catalysts for sustainable global nitrogen cycle.

### Materials and Methods

Synthesis of RuFe nanoflowers (NFs). In a typical experiment, 8 mg of Ru₃(CO)₁₂, 13.6 mg of Fe(acac)₃ and 10 mg of D-(+)-glucose were added into 4 mL of OAm. After ultrasonication for about 0.5 h, the resultant homogenous solution was mixed with 40 mg of citric acid and 2 mL of n-octanol. Then the mixture was ultrasonicated for another 0.5 h to obtain the homogenous solution. Subsequently, it was transferred to the Teflon-lined autoclave (25 mL capacity), which was heated from room temperature to 200° C. and kept at this temperature for 48 h. After the reaction, the final products were obtained by centrifugation and washed with 3 mL of the mixture of ethanol and hexane (v/v=1/1) for several times. The obtained RuFe NFs were redispersed into hexane for further use.

Synthesis of RuFe nanodendrites (NDs). In a typical synthesis, 8 mg of Ru3(CO)12 and 13.6 mg of Fe(acac)3 were added into 5 mL of OAm. After ultrasonication for around 10 mins, it was transferred to the Teflon-lined autoclave (25 mL capacity), and heated from room temperature to 220° C. and kept at this temperature for 14 h. The final products were collected by centrifugation and washed three times with 3 mL of the mixture of ethanol and hexane (v/v=1/1). The obtained RuFe NDs were re-dispersed into ethanol for further use.

Synthesis of Ru nanosheets (NSs). Typically, 4.5 mg of Ru(acac)3 was dissolved into 0.5 mL of OAm and 1.5 mL of benzyl alcohol through vigorous ultrasonication. Then the resultant transparent solution was transferred to the Teflon-lined autoclave (25 mL capacity), and heated from room temperature to 200° C. and kept at this temperature for 12 h. After it was cooled to room temperature naturally, the products were centrifugated and washed by 2 mL of the mixture of ethanol and hexane (v/v=1/3) for three times. Finally, the obtained products were re-dispersed into ethanol for further use.

Electrocatalytic measurements. The electrocatalytic test in this work was carried out in an H-type cell separated by an ion-exchange membrane (i.e., Nafion 117) at room temperature. The Ivium-n-Stat electrochemical workstation with multiple channels was utilized to record the electrochemical data. In a typical three-electrode system, a Pt plate, an Ag/AgCl (filled with saturated KCl solution) and the catalyst supported on carbon paper were used as the counter, reference and working electrodes, respectively. All the potentials of this work were converted to the reversible hydrogen electrode (RHE) scale by the following equation: E (vs RHE)=E (vs Ag/AgCl)+0.197 V+0.059×pH. For the electrocatalytic nitrate reduction, the solution composed of 0.5 M Na₂SO₄ and 0.1 M NaNO₃ was used as the electrolyte. Before the test, the solution was purged with high-purity argon (Ar) for at least 30 mins. Then 25 mL of electrolyte were added into the anode and cathode compartments of the H-type cell, respectively. Before the electrochemical measurements, the cyclic voltammetry (CV) was utilized to further remove the capping agents from the catalysts at a sweep rate of 50 mV s⁻¹. The linear sweep voltammetry (LSV) curve was obtained at a scan rate of 5 mV s⁻¹ with the potential range from 0 to −0.7 V (vs RHE). The chronoamperometry test was conducted for 1 h at each potential under a stirring rate of 600 rpm. After the electrolysis, the electrolyte was analyzed by the UV-vis spectrophotometer.

Characterization. The transmission electron microscopy (TEM) and the high-resolution TEM (HRTEM) images were taken on a JEOL-2100F transmission electron microscope operated at 200 kV. The spherical aberration-corrected high-angle annular dark-field scanning TEM (HAADF-STEM) images were obtained on a high-resolution aberration-corrected TEM (JEOL JEM-ARM200F). Scanning electron microscopy (SEM) measurement was conducted on QUANTA 250. Powder X-ray diffraction (XRD) patterns were recorded on a Rigaku SmartLab X-ray diffractometer with Cu Kα X-ray source (λ=1.5406 Λ). X-ray photoelectron spectroscopy (XPS) test was performed on Thermo Scientific Nexsa spectrophotometer with Al-Kα radiation system. X-ray absorption spectroscopy (XAS) measurements were conducted on the beamline 1W1B Beijing Synchrotron Radiation Facility with the transmission mode. A double-crystal Si (111) monochromator was applied to monochromatize the radiation.

Theoretical calculations setup. To compare the NO₃RR performance of the RuFe NFs and RuFe NDs, density functional theory (DFT) calculations have been introduced in this work within the CASTEP packages. The generalized gradient approximation (GGA) and the Perdew-Burke-Ernzerhof (PBE) were applied to accurately express the exchange-correlation interactions. We have set the plane-wave basis cutoff energy to 380 eV with the selection of the ultrasoft pseudopotentials. In particular, we applied the Broyden-Fletcher-Goldfarb-Shannon (BFGS) algorithm for the energy minimization and the k-point has been set to coarse quality. Both structures of RuFe NFs and RuFe NDs were cleaved from the hexagonal Ru unit cell with six atomic layers. The ratios of Ru:Fe are 51:53 and 59:49 for RuFe NFs and RuFe NDs, respectively, which are close to the experimental characterizations of 49:51 for RuFe NFs and 54.8:45.2 for RuFe NDs. More low-coordinated Ru sites were constructed on RuFe NFs surfaces. Meanwhile, a 20 Å vacuum space was applied in the z-axis to guarantee sufficient space for full relaxation. For all the geometry optimizations, we have considered the following convergence criteria: 1) the Hellmann-Feynman forces should not exceed 0.001 eV/Å; 2) the total energy difference should be smaller than 5×10⁵ eV/atom; and 3) the inter-ionic displacement of each atom should not exceed 0.005 Å.

What is claimed is:

1. A ruthenium-iron (RuFe) nanoflower particle comprising a plurality of RuFe nanosheets, wherein the plurality of RuFe nanosheets are in a form of a nanoflower.

2. The RuFe nanoflower particle of claim 1, wherein the plurality of RuFe nanosheets comprise RuFe in a hexagonal close-packed (hcp) phase.

3. The RuFe nanoflower particle of claim 1, wherein the RuFe nanoflower particle has a diameter of 150-250 nm.

4. The RuFe nanoflower particle of claim 1, wherein the plurality of RuFe nanosheets have an average thickness of 1-3 nm.

5. The RuFe nanoflower particle of claim 1, wherein the plurality of RuFe nanosheets have an average thickness of 1.5-2 nm.

6. The RuFe nanoflower particle of claim 1, wherein the RuFe nanoflower particle comprises Ru and Fe in an atomic ratio of 48:52 to 48.5:51.5, respectively.

7. The RuFe nanoflower particle of claim 1, wherein the RuFe nanoflower particle comprises Ru and Fe in an atomic ratio of 48.5:51.5 to 49.5:50.5, respectively.

8. The RuFe nanoflower particle of claim 1, wherein the RuFe nanoflower particle has an electrochemically active surface area of 200-267.5 cm².

9. The RuFe nanoflower particle of claim 1, wherein the RuFe nanoflower particle has a diameter of 150-250 nm; the plurality of RuFe nanosheets have an average thickness of 1.5-2 nm; and the RuFe nanoflower particle comprises Ru and Fe in an atomic ratio of 48.5:51.5 to 49.5:50.5, respectively.

10. The RuFe nanoflower particle of claim 1, wherein the RuFe nanoflower particle is prepared by a method comprising: contacting Ru₃(CO)₁₂, Fe(acac)₃, glucose, and citric acid in a solvent comprising oleylamine and n-octanol thereby forming a reaction solution and heating the reaction solution thereby forming the RuFe nanoflower particle.

11. The RuFe nanoflower particle of claim 10, wherein the reaction solution is heated at a temperature of 150-250° C.

12. An electrode comprising the ruthenium-iron (RuFe) nanoflower particle of claim 1 and a base electrode.

13. An electrochemical cell comprising:
the electrode of claim 12;
a counter electrode;
optionally a reference electrode; and
an electrolyte solution between and in contact with the electrode, the counter electrode, and optionally the reference electrode.

14. A method of producing ammonia, the method comprising: providing the electrochemical cell of claim 13, wherein the electrolyte solution comprises a substrate selected from the group consisting of a nitrate salt, a nitrite salt, nitric oxide, nitrogen (N₂), and mixtures thereof; and applying a potential between the electrode and the counter electrode resulting in the electrolytic reduction of the substrate thereby forming ammonia.

15. The method of claim 14, wherein the potential is −0.3 to −0.65 volts vs reversible hydrogen electrode.

16. The method of claim 14, wherein the nitrate salt is present in the electrolyte solution at a concentration of 0.01 to 0.1 M.

17. The method of claim 14, wherein the method has a NH₃ Faradaic efficiency (FE) of 87.1%-92.9% at −0.10 and −0.65 V vs reversible hydrogen evolution.

18. A method of preparing the RuFe nanoflower particle of claim 1, the method comprising: contacting Ru₃(CO)₁₂, Fe(acac)₃, glucose, and citric acid in a solvent comprising oleylamine and n-octanol thereby forming a reaction solution and heating the reaction solution thereby forming the RuFe nanoflower particle.

19. The method of claim 18, wherein the reaction solution is heated at a temperature of 150-300° C.

20. The method of claim 18, wherein Ru₃(CO)₁₂ and Fe(acac)₃ are contacted in a molar ratio less than 1:1, respectively.
